(19) United States
(12) Patent Application Publication
(10) Pub. No.: US 2024/0199047 A1
(43) Pub. Date: Jun. 20, 2024

(54) ONBOARDING AND OFFBOARDING AUTONOMOUS VEHICLES THROUGH AUGMENTED REALITY

(71) Applicant: International Business Machines Corporation, Armonk, NY (US)

(72) Inventors: Tushar Agrawal, West Fargo, ND (US); Jeremy R. Fox, Georgetown, TX (US); Atul Mene, Morrisville, NC (US); Sarbajit K. Rakshit, Kolkata (IN)

(21) Appl. No.: 18/065,786

(22) Filed: Dec. 14, 2022

(51) Int. Cl. B60W 50/14; B60W 60/00

(52) U.S. Cl. CPC B60W 50/14; B60W 60/001

(57) ABSTRACT

A computer system, computer program product, and computer-implemented method for enhancing offboarding of occupants associated with autonomous vehicles through augmented reality (AR). The method includes identifying that a first vehicle is approaching an occupant offboarding station, where the first vehicle is an autonomous vehicle. The method also includes determining a location of one or more second vehicles proximate to the occupant offboarding station. The method further includes determining, subject to the one or more second vehicles location determinations, an occupant offboarding location for the first vehicle proximate to the occupant offboarding station. The method also includes stopping the first vehicle proximate to the occupant offboarding location, including providing vehicular AR-based guidance to the first vehicle to stop.

### BACKGROUND

The present disclosure relates to enhancing operation of autonomous vehicles, and, more specifically, toward using augmented reality to enhance onboarding and offboarding of occupants of autonomous vehicles.

Many known vehicular transportation systems use one or more of augmented reality and autonomous vehicle driving features in collaboration with each other to define an autonomous vehicle system. For example, some known autonomous vehicle systems facilitate analyzing the surrounding traffic and thoroughfare conditions in real time and making driving decisions while the vehicle is autonomously driving through the traffic along the throughfare, i.e., with little to no human support. In addition, at least some of these known autonomous vehicle systems are configured to exchange the real time information through a networked architecture. Moreover, the networked autonomous vehicle systems are configured to exchange relevant information of each vehicle in the network. Such networked autonomous vehicle systems are also configured to share next actions and accordingly the vehicles are making and sharing collaborative driving decisions.

### SUMMARY

A system, product, and method are provided for using augmented reality to enhance onboarding and offboarding of occupants of autonomous vehicles.

In one aspect, a computer system for using augmented reality to enhance onboarding and offboarding of occupants of autonomous vehicles is presented. The system includes one or more processing devices, and one or more memory devices communicatively and operably coupled to the one or more processing devices. The system also includes an autonomous vehicles collaboration manager communicatively and operably coupled to the one or more processing devices. The system further includes one or more AR devices communicatively and operably coupled to the autonomous vehicles collaboration manager. The autonomous vehicles collaboration manager is configured to identify that a first vehicle is approaching an occupant offboarding station, where the first vehicle is an autonomous vehicle. The autonomous vehicles collaboration manager is also configured to determine a location of one or more second vehicles proximate to the occupant offboarding station. The autonomous vehicles collaboration manager is further configured to determine, subject to the one or more second vehicles location determinations, an occupant offboarding location for the first vehicle proximate to the occupant offboarding station. The autonomous vehicles collaboration manager is also configured to stop the first vehicle proximate to the occupant offboarding location through providing vehicular AR-based guidance to the first vehicle to stop.

In another aspect, a computer program product is presented. The product includes one or more computer readable storage media and program instructions collectively stored on the one or more computer storage media. The program instructions include program instructions to execute one or more operations for using augmented reality to enhance onboarding and offboarding of occupants of autonomous vehicles. The program instructions include program instructions to identify that a first vehicle is approaching an occupant offboarding station, where the first vehicle is an autonomous vehicle. The program instructions also include program instructions to determine a location of one or more second vehicles proximate to the occupant offboarding station. The program instructions further include program instructions to determine, subject to the one or more second vehicles location determinations, an occupant offboarding location for the first vehicle proximate to the occupant offboarding station. The program instructions also include program instructions to stop the first vehicle proximate to the occupant offboarding location through providing vehicular AR-based guidance to the first vehicle to stop.

In yet another aspect, a computer-implemented method for using augmented reality to enhance onboarding and offboarding of occupants of autonomous vehicles is presented is presented. The method includes identifying that a first vehicle is approaching an occupant offboarding station, where the first vehicle is an autonomous vehicle. The method also includes determining a location of one or more second vehicles proximate to the occupant offboarding station. The method further includes determining, subject to the one or more second vehicles location determinations, an occupant offboarding location for the first vehicle proximate to the occupant offboarding station. The method also includes stopping the first vehicle proximate to the occupant offboarding location, including providing vehicular AR-based guidance to the first vehicle to stop.

The present Summary is not intended to illustrate each aspect of every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1A is a block schematic diagram illustrating a computer system including an artificial intelligence platform suitable for leveraging a trained cognitive system to facilitate using augmented reality to enhance onboarding and offboarding of occupants of autonomous vehicles, in accordance with some embodiments of the present disclosure.

FIG. 1B is a block schematic diagram illustrating the artificial intelligence platform shown in FIG. 1A, in accordance with some embodiments of the present disclosure.

FIG. 1C is a block schematic diagram illustrating a data library shown in FIG. 1A, in accordance with some embodiments of the present disclosure.

FIG. 2 is a block schematic diagram illustrating one or more artificial intelligence platform tools, as shown and described with respect to FIGS. 1A-1C, and their associated application program interfaces, in accordance with some embodiments of the present disclosure.

FIG. 3 is a schematic diagram illustrating an autonomous vehicle in a plurality of onboarding/offboarding configurations that may be used in conjunction with the system shown in FIGS. 1A-2, in accordance with some embodiments of the present disclosure.

FIG. 4A is a schematic diagram illustrating one possible parking configuration for a plurality of autonomous vehicles shown in FIG. 3 using the system shown in FIGS. 1A-2, in accordance with some embodiments of the present disclosure.

FIG. 4B is a schematic diagram illustrating one possible parking configuration for a plurality of autonomous vehicles shown in FIG. 3 using the system shown in FIGS. 1A-2, in accordance with some embodiments of the present disclosure.

FIG. 4C is a schematic diagram illustrating one possible parking configuration for a plurality of autonomous vehicles shown in FIG. 3 using the system shown in FIGS. 1A-2, in accordance with some embodiments of the present disclosure.

FIG. 5 is a schematic diagram illustrating one possible occupant offboarding and onboarding configuration for a plurality of autonomous vehicles shown in FIG. 3 using the system shown in FIGS. 1A-2, in accordance with some embodiments of the present disclosure.

FIG. 6 is a schematic diagram illustrating one possible augmented reality assist for a driver of a vehicle similar to the autonomous vehicles shown in FIG. 3 using the system shown in FIGS. 1A-2, in accordance with some embodiments of the present disclosure.

FIG. 7 is a schematic diagram illustrating one possible augmented reality assist for a plurality of occupants transiting from their respective autonomous vehicles using the system shown in FIGS. 1A-2, in accordance with some embodiments of the present disclosure.

FIG. 8 is a flowchart illustrating a process for using augmented reality to enhance onboarding and offboarding of occupants of autonomous vehicles, in accordance with some embodiments of the present disclosure.

FIG. 9 is as block schematic diagram illustrating an example of a computing environment for the execution of at least some of the computer code involved in performing the disclosed methods described herein, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to for using augmented reality to enhance onboarding and offboarding of occupants of autonomous vehicles. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

As used herein, “facilitating” an action includes performing the action, making the action easier, helping to carry the action out, or causing the action to be performed. Thus, by way of example and not limitation, instructions executing on one processor might facilitate an action carried out by semiconductor processing equipment, by sending appropriate data or commands to cause or aid the action to be performed. Where an actor facilitates an action by other than performing the action, the action is nevertheless performed by some entity or combination of entities.

Many known vehicular transportation systems use one or more of augmented reality and autonomous vehicle driving features in collaboration with each other to define an autonomous vehicle system. For example, some known autonomous vehicle systems facilitate analyzing the surrounding traffic and thoroughfare conditions in real time and making driving decisions while the vehicle is autonomously driving through the traffic along the throughfare, i.e., with little to no human support. In addition, at least some of these known autonomous vehicle systems are configured to exchange the real time information through a networked architecture. Moreover, the networked autonomous vehicle systems are configured to exchange relevant information of each vehicle in the network. Such networked autonomous vehicle systems are also configured to share next actions and accordingly the vehicles are making and sharing collaborative driving decisions.

However, the known networked autonomous vehicle systems no longer communicate in a collaborative manner once the respective vehicles begin the parking process. More specifically, each respective vehicle is parked as a stand-alone process. In any location, if multiple people need to depart from or board in their respective vehicles, one-by-one serialized exiting and boarding of the vehicles will take a certain period of time. In addition, large-enough gaps among the vehicles will requiring a certain amount of space. In addition, for those vehicles parked too close together, if multiple occupants are opening their respective vehicle doors, then a potential for a door-to-door impact is heightened. Moreover, in some instances, at least some of the occupants will have to exit or board their respective vehicles with difficulty, and in some cases, ingress and egress of the vehicle is not possible. Accordingly, extending the vehicle-to-vehicle collaborative information sharing during parking activities will more effectively and efficiently position the multiple vehicles for enhanced space usage and vehicle ingress/egress.

Systems, computer program products, and methods are disclosed and described herein for enhancing operation of autonomous vehicles, and, more specifically, toward using augmented reality to enhance onboarding and offboarding of occupants of autonomous vehicles. Such operational enhancements include, without limitation, automatic collection, generation, and presentation of real time information to vehicular occupants, and, more specifically, to automatically and dynamically provide recommendations and insights to the passengers and operator of a vehicle while travelling therein with respect to parking or stopping the vehicle and offboarding and onboarding thereof. In some embodiments, the autonomous vehicles are guided through and the occupants exit from a parking facility. In some embodiments, the autonomous vehicles are guided through and the occupants exit from the vehicles at a stopping area that is not a parking area.

Moreover, the systems, computer program products, and methods facilitate collaboration between autonomous vehicles and augmented reality to identify if the occupants from multiple vehicles may need to be dropped off at the same location or within a shorter distance to a designated occupant pathway. In such cases, the systems, computer program products, and methods identify a pattern for making the stops in such a way that the first stop doesn't interfere with the second and so on when multiple vehicles are stopped at the same time at a given spot/stop. This allows for an optimized number of vehicles at an area e.g., entertainment events, airports, hospitals, schools, etc. The systems, computer program products, and methods further guide occupants (through augmented reality overlays) to the paths to exit from and entry into the respective vehicles as appropriate to prevent any door collisions, mitigate traffic congestion, etc. The systems, computer program products, and methods also proactively assign occupants going towards the same stop in the same vehicle as well.

The terms “operator,” “operators,” “driver,” and “drivers” are used interchangeably herein. The systems, computer program products, and methods disclosed herein integrate artificial intelligence, machine learning features, simulation, augmented reality, and aspects of virtual reality. In addition, the terms “offboarding.” “unloading.” and “exiting a vehicle,” and similar terms are used interchangeably herein. Moreover, the terms “onboarding.” “loading.” and “entering a vehicle” and similar terms are used interchangeably herein.

In at least some embodiments, the systems, computer program products, and methods described herein facilitate offboarding and onboarding occupants with respect to autonomous vehicles through implementing of contextualizing vehicular collaboration with augmented reality. The autonomous vehicles collaborate with each other to identify if occupants from multiple vehicles need to offboard from their respective vehicles at the same point of time within a parking complex or vehicle loading area for a limited period of time, e.g., and without limitation, shopping centers, sports stadiums, airports, schools, etc. Such autonomous vehicles also collaborate with each other to identify how the vehicles will be stopping, so that opening a door of one vehicle will not be creating an obstacle to occupants of other vehicle, and a chance for any door-to-door impacts, even if the vehicle doors for both vehicles are opened at the same point of time.

Also, in at least some embodiments, the systems, computer program products, and methods described herein facilitate a reduction of the space utilization for parking autonomous vehicles through implementing overlaying space minimization requirements. Specifically, the autonomous vehicles collaborate in such a way that, within the parameters established for the parking space utilization, an optimum number of occupants can offboard from their respective autonomous vehicles using the most efficient amount of parking area and the most efficient time period, such that an optimum number of vehicles can be accommodated for occupant offboarding.

Moreover, in at least some embodiments, the systems, computer program products, and methods described herein implement the use of augmented reality for highlighting respective walking occupant pathways. Specifically, based on a relative position of a first vehicle with respect to one or more second vehicles with respect to opening a door of the one or more second vehicles, the side of the vehicle with the door that will be opened for occupants to offboard will be identified, and the other side of the vehicle is utilized as a walking passage for the occupants to facilitate offboarding and occupant transit from the respective parking areas. Also, specifically, logical autonomous vehicle door path planning is implemented with respect to open and closed doors for the vehicles for onboarding as well as offboarding. For example, and without limitation, if multiple people need to onboard in different autonomous vehicles at the exact same time, then the collaborating autonomous vehicles identify how the autonomous collaborating vehicles will be planning and executing the plans in their respective vicinities such that appropriate passage for each of the respective occupants to move in an optimum manner to their respective vehicles is facilitated. As such, the vehicles will be identifying to the occupants which sides or the respective vehicles will have open doors and which sides have closed doors. In addition, iterative movement and planning via augmented reality is implemented such that during onboarding, the autonomous vehicles collaborate with each other, identify each occupant's position, and identifies the optimum positions of the vehicles. Also, with augmented reality, the respective occupants are guided to onboard their respective vehicles. For those occupants that are not wearing augmented reality glasses, they will be able to use their phones and evaluate with an augmented reality overlay through portable devices, e.g., and without limitation, a smartphone.

Furthermore, in at least some embodiments, the systems, computer program products, and methods described herein implement augmented reality real time tracking and user feedback. Specifically, the progress of each occupant traveling towards their respective vehicle to onboard is tracked in real time, and the appropriate side of the vehicle's doors is unlocked, and in some embodiments, opened. Moreover, in some embodiments, based on historical learning with respect to the occupant loading and the parking vicinity, the system will determine how the vehicles will be placed, the spacing between the vehicles, etc.

In addition, environmental conditions such as weather (gloomy, cloudy, rainy, hot and humid, etc.) and the road conditions are incorporated into the implementation of the embodiments described herein. Furthermore, at least some occupant profiles include the attributes of the occupants boarded including, without limitation, preferred driver parking vicinities, required level of assistance for boarding and exiting the vehicle, preferred routes and destinations, etc.

In at least some embodiments, the information used to facilitate collaboration between the vehicles includes leveraging Internet of Things (IoT) techniques including, but not limited to, vehicle-to-vehicle (V2V) and vehicle-to-infrastructure (V2I) communication techniques.

In at least some embodiments, the system, computer program product, and method described herein use an artificial intelligence platform. “Artificial Intelligence” (AI) is one example of cognitive systems that relate to the field of computer science directed at computers and computer behavior as related to humans and man-made and natural systems. Cognitive computing utilizes self-teaching algorithms that use, for example, and without limitation, data analysis, visual recognition, behavioral monitoring, and natural language processing (NLP) to solve problems and optimize human processes. The data analysis and behavioral monitoring features analyze the collected relevant data and behaviors as subject matter data as received from the sources as discussed herein. As the subject matter data is received, organized, and stored, the data analysis and behavioral monitoring features analyze the data and behaviors to determine the relevant details through computational analytical tools which allow the associated systems to learn, analyze, and understand human behavior, including within the context of the present disclosure. With such an understanding, the AI can surface concepts and categories, and apply the acquired knowledge to teach the AI platform the relevant portions of the received data and behaviors. In addition to analyzing human behaviors and data, the AI platform may also be taught to analyze data and behaviors of man-made and natural systems.

In addition, cognitive systems such as AI, based on information, are able to make decisions, which maximizes the chance of success in a given topic. More specifically, AI is able to learn from a dataset, including behavioral data, to solve problems and provide relevant recommendations. For example, in the field of artificial intelligent computer systems, machine learning (ML) systems process large volumes of data, seemingly related or unrelated, where the ML systems may be trained with data derived from a database or corpus of knowledge, as well as recorded behavioral data. The ML systems look for, and determine, patterns, or lack thereof, in the data, “learn” from the patterns in the data, and ultimately accomplish tasks without being given specific instructions. In addition, the ML systems, utilizes algorithms, represented as machine processable models, to learn from the data and create foresights based on this data. More specifically, ML is the application of AI, such as, and without limitation, through creation of neural networks that can demonstrate learning behavior by performing tasks that are not explicitly programmed. Deep learning is a type of neural-network ML in which systems can accomplish complex tasks by using multiple layers of choices based on output of a previous layer, creating increasingly smarter and more abstract conclusions.

ML learning systems may have different “learning styles.” One such learning style is supervised learning, where the data is labeled to train the ML system through telling the ML system what the key characteristics of a thing are with respect to its features, and what that thing actually is. If the thing is an object or a condition, the training process is called classification. Supervised learning includes determining a difference between generated predictions of the classification labels and the actual labels, and then minimize that difference. If the thing is a number, the training process is called regression. Accordingly, supervised learning specializes in predicting the future.

A second learning style is unsupervised learning, where commonalities and patterns in the input data are determined by the ML system through little to no assistance by humans. Most unsupervised learning focuses on clustering, i.e., grouping the data by some set of characteristics or features. These may be the same features used in supervised learning, although unsupervised learning typically does not use labeled data. Accordingly, unsupervised learning may be used to find outliers and anomalies in a dataset, and cluster the data into several categories based on the discovered features.

Semi-supervised learning is a hybrid of supervised and unsupervised learning that includes using labeled as well as unlabeled data to perform certain learning tasks. Semi-supervised learning permits harnessing the large amounts of unlabeled data available in many use cases in combination with typically smaller sets of labelled data. Semi-supervised classification methods are particularly relevant to scenarios where labelled data is scarce. In those cases, it may be difficult to construct a reliable classifier through either supervised or unsupervised training. This situation occurs in application domains where labelled data is expensive or difficult obtain, like computer-aided diagnosis, drug discovery and part-of-speech tagging. If sufficient unlabeled data is available and under certain assumptions about the distribution of the data, the unlabeled data can help in the construction of a better classifier through classifying unlabeled data as accurately as possible based on the documents that are already labeled.

The third learning style is reinforcement learning, where positive behavior is “rewarded: and negative behavior is “punished.” Reinforcement learning uses an “agent,” the agent's environment, a way for the agent to interact with the environment, and a way for the agent to receive feedback with respect to its actions within the environment. An agent may be anything that can perceive its environment through sensors and act upon that environment through actuators. Therefore, reinforcement learning rewards or punishes the ML system agent to teach the ML system how to most appropriately respond to certain stimuli or environments. Accordingly, over time, this behavior reinforcement facilitates determining the optimal behavior for a particular environment or situation.

Deep learning is a method of machine learning that incorporates neural networks in successive layers to learn from data in an iterative manner. Neural networks are models of the way the nervous system operates. Basic units are referred to as neurons, which are typically organized into layers. The neural network works by simulating a large number of interconnected processing devices that resemble abstract versions of neurons. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to every neuron in the next layer. At a basic level, each layer of the neural network includes one or more operators or functions operatively coupled to output and input. Output from the operator(s) or function(s) of the last hidden layer is referred to herein as activations. Eventually, a result is delivered from the output layers. Deep learning complex neural networks are designed to emulate how the human brain works, so computers can be trained to support poorly defined abstractions and problems. Therefore, deep learning is used to predict an output given a set of inputs, and either supervised learning or unsupervised learning can be used to facilitate such results.

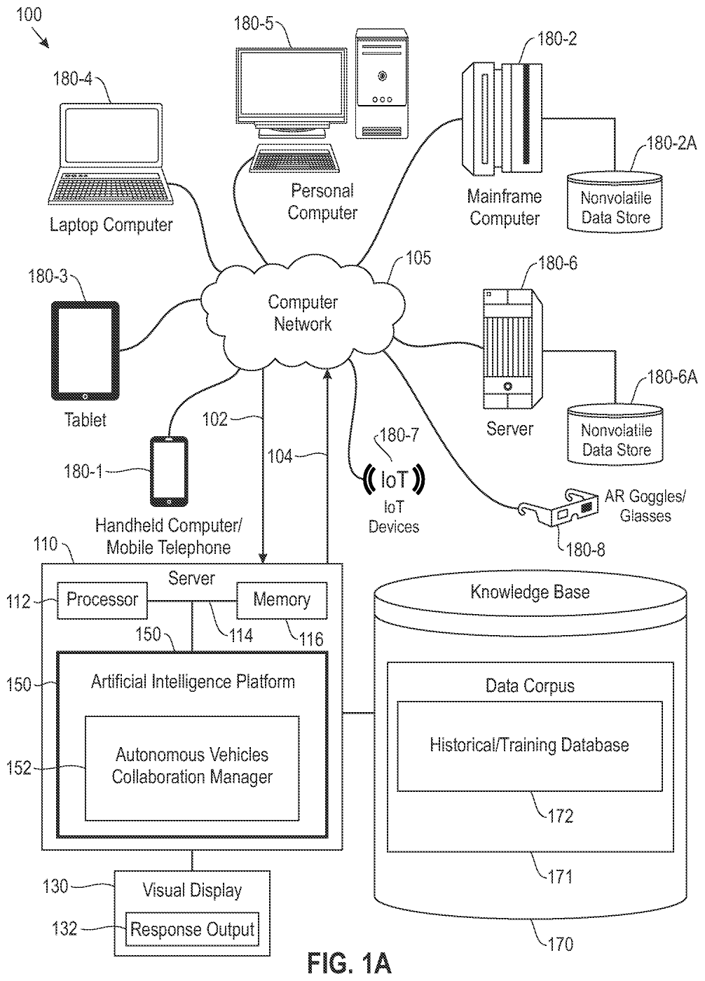

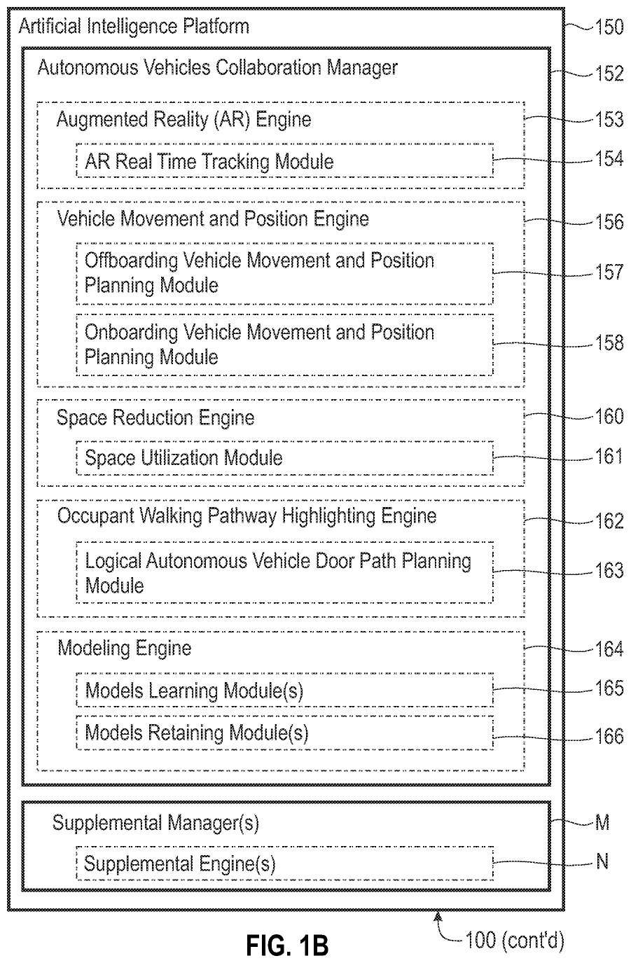

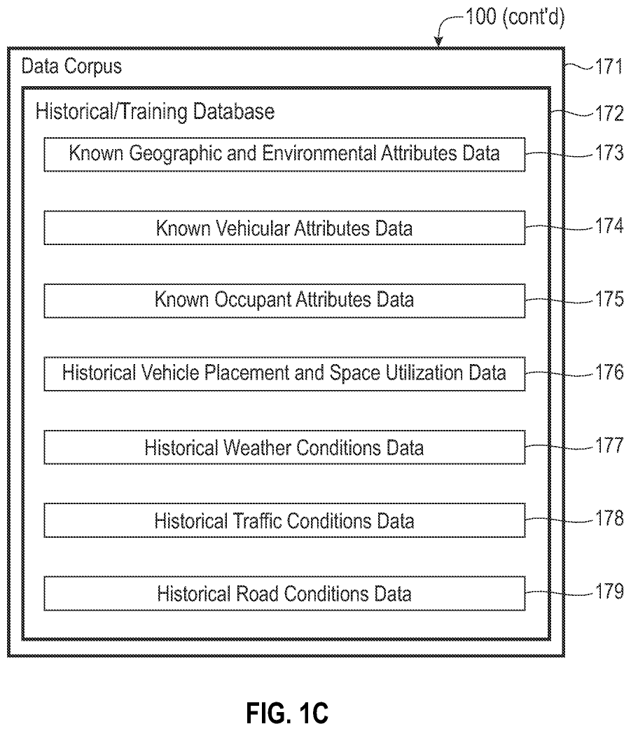

Referring to FIG. 1A, a schematic diagram is presented illustrating a computer system 100, that in the embodiments described herein, is a vehicular information system 100, herein referred to as the system 100. As described further herein, system 100 is configured for enhancing operation of autonomous vehicles, and, more specifically, toward using augmented reality to enhance onboarding and offboarding of occupants of autonomous vehicles. Such operational enhancements include, without limitation, automatic collection, generation, and presentation of real time information to vehicular occupants, and, more specifically, to automatically and dynamically provide recommendations and insights to the occupants and operator of a vehicle while travelling therein with respect to parking the vehicle and offboarding and onboarding thereof. In at least one embodiment, the system 100 includes one or more automated machine learning (ML) system features to leverage a trained cognitive system, in corroboration with embedded augmented reality (AR) features to automatically and dynamically provide the aforementioned recommendations and insights to the occupants and operators of their respective vehicles. In at least one embodiment, the system 100 is embodied as a cognitive system, i.e., an artificial intelligence (AI) platform computing system that includes an artificial intelligence platform 150 suitable for establishing the environment to facilitate the collection, generation, and presentation of real time information and instructions with respect to parking, offboarding, and onboarding to the respective vehicular occupants.

As shown, a server 110 is provided in communication with a plurality of information handling devices 180 (sometimes referred to as information handling systems, computing devices, and computing systems) across a computer network connection 105. The computer network connection 105 may include several information handling devices 180. Types of information handling devices that can utilize the system 100 range from small handheld devices, such as a handheld computer/mobile telephone 180-1 to large mainframe systems, such as a mainframe computer 180-2. Additional examples of information handling devices include personal digital assistants (PDAs), personal entertainment devices, pen or tablet computer 180-3, laptop or notebook computer 180-4, personal computer system 180-5, server 180-6, one or more Internet of Things (IoT) devices 180-7, that in at least some embodiments, include connected cameras and environmental sensors, and AR glasses or goggles 180-8. As shown, the various information handling devices, collectively referred to as the information handling devices 180, are networked together using the computer network connection 105.

Various types of a computer networks can be used to interconnect the various information handling systems, including Local Area Networks (LANs), Wireless Local Area Networks (WLANs), the Internet, the Public Switched Telephone Network (PSTN), other wireless networks, and any other network topology that can be used to interconnect information handling systems and computing devices as described herein. In at least some embodiments, at least a portion of the network topology includes cloud-based features. Many of the information handling devices 180 include non-volatile data stores, such as hard drives and/or non-volatile memory. Some of the information handling devices 180 may use separate non-volatile data stores, e.g., server 180-6 utilizes non-volatile data store 180-6A, and mainframe computer 180-2 utilizes non-volatile data store 180-2A. The non-volatile data store 180-2A can be a component that is external to the various information handling devices 180 or can be internal to one of the information handling devices 180.

The server 110 is configured with a processing device 112 in communication with memory device 116 across a bus 114. The server 110 is shown with the artificial intelligence (AI) platform 150 for cognitive computing, including machine learning, over the computer network connection 105 from one or more of the information handling devices 180. More specifically, the information handling devices 180 communicate with each other and with other devices or components via one or more wired and/or wireless data communication links, where each communication link may comprise one or more of wires, routers, switches, transmitters, receivers, or the like. In this networked arrangement, the server 110 and the computer network connection 105 enable communication, detection, recognition, and resolution. The server 110 is in operable communication with the computer network through communications links 102 and 104. Links 102 and 104 may be wired or wireless. Other embodiments of the server 110 may be used with components, systems, sub-systems, and/or devices other than those that are depicted herein.

The AI platform 150 is shown herein configured with tools to enable automatic collection, generation, and presentation of real time information to vehicular occupants. More specifically, the AI platform 150 is configured for leveraging a trained cognitive system to automatically and dynamically enhance operation of autonomous vehicles, and, more specifically, toward using augmented reality to enhance onboarding and offboarding of occupants of autonomous vehicles. Such operational enhancements include, without limitation, automatic collection, generation, and presentation of real time information to vehicular occupants, and, more specifically, to automatically and dynamically provide recommendations and insights to the passengers and operator of a vehicle while travelling therein with respect to parking the vehicle and offboarding and onboarding thereof. In one embodiment, one or more high-fidelity machine learning (ML) models of the vehicle operators (drivers), the passengers, and the routes is resident within the AI platform 150. Herein, the terms “model” and “models” includes “one or more models.” Therefore, as a portion of data ingestion by the model, data resident within a knowledge base 170 is injected into the model as described in more detail herein. Accordingly, the AI platform 150 includes a learning-based mechanism that can facilitate training of the model with respect to the drivers, passengers, and routes to facilitate an effective vehicular information system 100.

The tools embedded within the AI platform 150 as shown and described herein include, but are not limited to, an autonomous vehicles collaboration manager 152 that is described further with respect to FIG. 1B. Referring to FIG. 1B, a block schematic diagram is provided illustrating the AI platform 150 shown in FIG. 1A with greater detail, in accordance with some embodiments of the present disclosure. Continuing to also refer to FIG. 1A, and continuing the numbering sequence thereof, the autonomous vehicles collaboration manager 152 includes an augmented reality (AR) engine 153 with an AR real time tracking module 154 embedded therein. The autonomous vehicles collaboration manager 152 also includes a vehicle movement and position engine 156 that includes an offboarding vehicle movement and position planning module 157 and an onboarding vehicle movement and position planning module 158 embedded therein. The autonomous vehicles collaboration manager 152 also includes a space reduction engine 160 that includes a space utilization module 161.

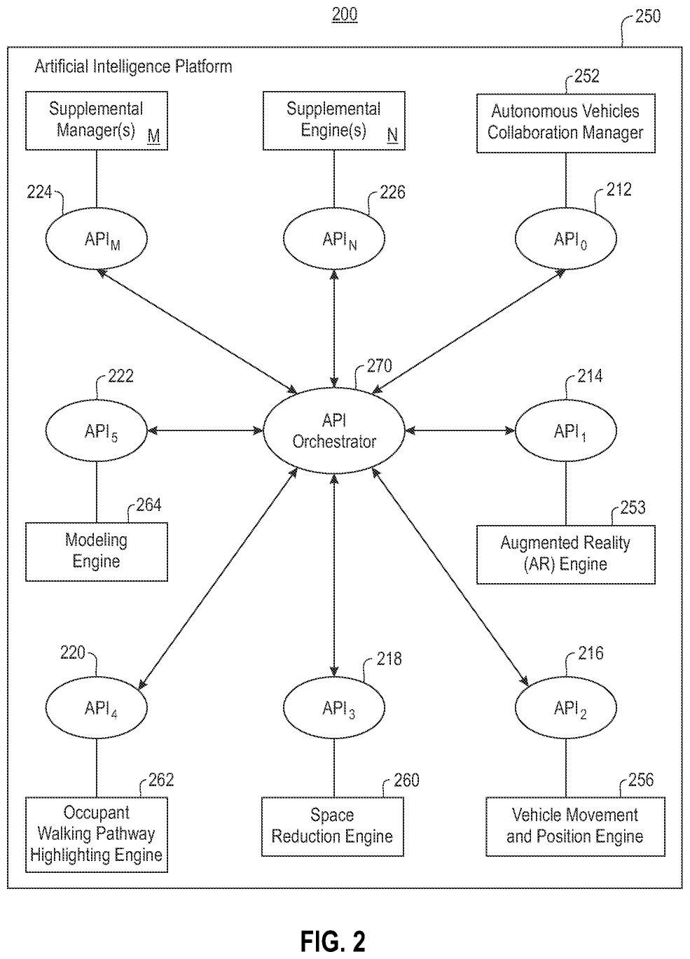

The autonomous vehicles collaboration manager 152 further includes an occupant walking pathway highlighting engine 162 that includes a logical autonomous vehicle door path planning module 163 embedded therein. The autonomous vehicles collaboration manager 152 also includes a modeling engine 164. The modeling engine 164 includes one or more models learning modules 165 and one or more models retaining modules 166 embedded therein. The models learning modules 165 are configured to train the models that are resident in the models retaining modules 166. The aforementioned managers and engines are described further herein with respect to FIGS. 2 through 8. In some embodiments, the AI platform 150 includes one or more supplemental managers M (only one shown) and one or more supplemental engines N (only one shown) that are employed for any supplemental functionality in addition to the functionality described herein. The one or more supplemental managers M and the one or more supplemental engines N include any number of modules embedded therein to enable the functionality of the respective managers M and engines N.

Referring again to FIG. 1A, the AI platform 150 may receive input from the computer network connection 105 and leverage the knowledge base 170, also referred to herein as a data source, to selectively access training and other data. The knowledge base 170 is communicatively and operably coupled to the server 110 including the processing device 112 and/or memory 116. In at least one embodiment, the knowledge base 170 may be directly communicatively and operably coupled to the server 110. In some embodiments, the knowledge base 170 is communicatively and operably coupled to the server 110 across the computer network connection 105. In at least one embodiment, the knowledge base 170 includes a data corpus 171 that in some embodiments, is referred to as a data repository, a data library, and knowledge corpus, that may be in the form of one or more databases. The data corpus 171 is described further with respect to FIG. 1C.

Referring to FIG. 1C, a block schematic diagram is presented illustrating the data corpus 171 shown in FIG. 1A with greater detail, in accordance with some embodiments of the present disclosure. Continuing to also refer to FIG. 1A, and continuing the numbering sequence thereof, the data corpus 171 includes different databases, including, but not limited to, a historical/training database 172 that includes, without limitation, known geographic and environmental attributes data 173, known vehicular attributes data 174, known occupant (includes any drivers) attributes data 175, historical vehicle placement and space utilization 176, historical weather conditions data 177, historical traffic conditions 178, and historical road conditions data 179. The respective databases and the resident data therein are described further herein with respect to FIGS. 2 through 8. In some embodiments, at least a portion of the historical/training database 172 is used to train the models (not shown) associated with the autonomous vehicles collaboration manager 152. Accordingly, the server 110, including the AI platform 150 and the autonomous vehicles collaboration manager 152, receive information through the computer network connection 105 from the devices connected thereto and the knowledge base 170.

Referring again to FIG. 1A, a response output 132 includes, for example, and without limitation, output generated in response to a query of the data corpus 171 that may include some combination of the datasets resident therein. Further details of the information displayed is described with respect to FIGS. 2 through 8.

In at least one embodiment, the response output 132 is communicated to a corresponding network device, shown herein as a visual display 130, communicatively and operably coupled to the server 110 or in at least one other embodiment, operatively coupled to one or more of the computing devices across the computer network connection 105.

The computer network connection 105 may include local network connections and remote connections in various embodiments, such that the artificial intelligence platform 150 may operate in environments of any size, including local and global, e.g., the Internet. Additionally, the AI platform 150 serves as a front-end system that can make available a variety of knowledge extracted from or represented in network accessible sources and/or structured data sources. In this manner, some processes populate the AI platform 150, with the AI platform 150 also including one or more input interfaces or portals to receive requests and respond accordingly.

Referring to FIG. 2, a block schematic diagram 200 is presented illustrating one or more artificial intelligence platform tools, as shown and described with respect to FIG. 1, and their associated application program interfaces, in accordance with some embodiments of the present disclosure. An application program interface (API) is understood in the art as a software intermediary, e.g., invocation protocol, between two or more applications which may run on one or more computing environments. As shown, a tool is embedded within the AI platform 250 (shown and described in FIGS. 1A and 1B as the AI platform 150), one or more APIs may be utilized to support one or more of the tools therein, including the autonomous vehicles collaboration manager 252 (shown and described as the autonomous vehicles collaboration manager 152 with respect to FIGS. 1A and 1B) and its associated functionality. Accordingly, the AI platform 250 includes the tools including, but not limited to, the autonomous vehicles collaboration manager 252 associated with an API₀ 212.

The API₀ 212 may be implemented in one or more languages and interface specifications. API₀ 212 provides functional support for, without limitation, autonomous vehicles collaboration manager 252 that is configured to facilitate execution of one or more operations by the server 110 (shown in FIG. 1A). Such operations include, without limitation, collecting, storing, and recalling the data stored within the data corpus 171 as discussed herein, and providing data management and transmission features not provided by any other managers or tools (not shown). Accordingly, the autonomous vehicles collaboration manager 252 is configured to facilitate building, storing, and managing the data in the data corpus 171 including, without limitation, joining of the data resident therein.

In at least some embodiments, the components, i.e., the additional support tools, embedded within the autonomous vehicles collaboration manager 252 include an augmented reality (AR) engine 253 (referred to as the augmented reality (AR) engine 153 in FIG. 1B including the embedded AR real time tracking module 154), the vehicle movement and position engine 256 (referred to as the vehicle movement and position engine 156 in FIG. 1B including the embedded offboarding vehicle movement and position planning module 157 and the onboarding vehicle movement and position planning module 158), a space reduction engine 260 (referred to as the space reduction engine 160 that includes the space utilization module 161), an occupant walking pathway highlighting engine 262 (referred to as the occupant walking pathway highlighting engine 162 including the embedded logical autonomous vehicle door path planning module 163), and the modeling engine 264 (referred to as the modeling engine 164 including the embedded models module 166 that includes, without limitation, the models resident therein) that are also implemented through respective APIs. Specifically, the augmented reality (AR) engine 253 is associated with an API₁ 214, vehicle movement and position engine 256 is associated with an API₂ 216, the space reduction engine 260 is associated with an API₃ 218, the occupant walking pathway highlighting engine 262 is associated with an API₄ 220, and the modeling engine 264 is associated with an API₅ 222. Accordingly, the APIs API₀ 212 through API₅ 222 provide functional support for the operation of the autonomous vehicles collaboration manager 152/252 through the respective embedded tools.

In some embodiments, as described for FIG. 1A, the AI platform 150 includes one or more supplemental managers M (only one shown) and one or more supplemental engines N (only one shown) that are employed for any supplemental functionality in addition to the functionality described herein. Accordingly, the one or more supplemental managers M are associated with one or more APIs_{M} 224 (only one shown) and the one or more supplemental engines N are associated with one or more APIs_{N} 226 (only one shown) to provide functional support for the operation of the one or more supplemental managers M through the respective embedded tools.

As shown, the APIs API₀ 212 though API_{N} 226 are operatively coupled to an API orchestrator 270, otherwise known as an orchestration layer, which is understood in the art to function as an abstraction layer to transparently thread together the separate APIs. In at least one embodiment, the functionality of the APIs API₀ 212 though API_{N} 226, and any additional APIs, may be joined or combined. As such, the configuration of the APIs API₀ 212 through API_{N} 226 shown herein should not be considered limiting. Accordingly, as shown herein, the functionality of the tools may be embodied or supported by their respective APIs API₀ 212 through API_{N} 226.

In at least some embodiments, and referring to FIGS. 1A through 1C, as well as FIG. 2, the tools embedded within the AI platform 150 as shown and described herein include, but are not limited to, the following functionalities that are loosely separated into vehicle-centric and occupant-centric functionalities. In addition, the AI platform 150 uses at least a portion of the data resident within the data corpus 171, and more specifically, the historical database 172.

The augmented reality (AR) engine 153/253 with the AR real time tracking module 154 embedded therein facilitates one or more vehicle-centric functions that include, without limitation, the respective autonomous vehicles analyzing the surrounding vicinity and identifying how the autonomous vehicles are to be placed to position the optimum number of vehicles in the designated area constraints. In some embodiments, the AR engine 153/253 uses the known geographic and environmental attributes data 173, the known vehicular attributes data 174, and the historical vehicle placement and space utilization data 176. Also, in some embodiments, the historical weather conditions data 177, the historical traffic conditions data 178, and the historical road conditions data 179 are also used if necessary as a function of the location of offboarding and onboarding of occupants.

In at least some embodiments, the known geographic and environmental attributes data 173 includes data such as, and without limitation, geographical arrangements of the parking facilities, speed and parking signage, pedestrian walkways and crosswalks, handicapped parking spaces, etc. In some embodiments, the known vehicular attributes data 174 includes data such as, and without limitation, vehicle make, model, and year, vehicle dimension data, including door length and span data, number and placement of doors, seating capacities of the vehicles, occupant access features for all doors, including rear hatchbacks, electric vehicle charging requirements, any ramps (for handicapped parking), stairs (for busses and vans), etc. In some embodiments, the historical vehicle placement and space utilization data 176 includes data such as, and without limitation, prior parking experiences at specific locations, including actions that resulted in satisfactory experiences for the occupants of the present vehicle and adjacent vehicles, and actions that resulted in less than satisfactory experiences. Moreover, over a period of time, the system 100 tracks occupant progress towards either an exit or the respective vehicle and continues to build a knowledge corpus within the historical vehicle placement and space utilization data 176 as to how the vehicles should be placed and what doors should be opened/locked, the amount of space between two vehicles etc. The modeling engine 164 uses this corpus to predict and identify a pattern for occupant offboarding and onboarding and vehicle parking in such a way that a first vehicle's stop doesn't interfere (door collision or obstacle for the occupants) with a second vehicle when multiple vehicles are stopped at the same time at a given spot/stop. Accordingly, the system 100 leverages optimization techniques to ensure that with a minimum space utilization for parked or stopped vehicles, a maximum number of occupants can exit or enter their respective vehicles at an area such as, and without limitation, airports, hospitals, schools, event venues, and the like.

Such known geographic and environmental attributes data 173, known vehicular attributes data 174, and historical vehicle placement and space utilization data 176 are used to perform the initial training of the models resident in the models retaining modules 166 through the models learning modules 165.

In some embodiments, the autonomous vehicles collaboration manager 152/252 is configured to update the models therein through the models learning modules 165 with infrastructure changes to the parking facilities. For example, in advance of a parking activity of a particular vehicle in a particular parking facility, the information handling devices 180 are leveraged to import details of the changes and adjust the relevant models accordingly prior to the vehicle arriving at the parking facility. In addition, the augmented reality features of the autonomous vehicles collaboration manager 152/252 facilitate real time inclusion of structural changes to the infrastructure to enhance the goals of compact parking of the vehicles and best mode passage of the occupants to and from the respective vehicles.

Also, in some embodiments, the historical weather conditions data 177, the historical traffic conditions data 178, and the historical road conditions data 179 are also used if necessary as a function of the location of offboarding and onboarding of occupants. The historical weather conditions data 177 includes, without limitation, those weather conditions conducive to executing the operations of the vehicular information system 100, including the autonomous vehicles collaboration manager 152/252 and the engines embedded therein. In addition, the historical weather conditions data 177 includes, without limitation, those weather conditions unfavorable to executing the operations of the vehicular information system 100, including the autonomous vehicles collaboration manager 152/252 and the engines embedded therein. For example, and without limitation, inclement weather will necessarily induce the trained models in the artificial intelligence platform 150 to alter, as necessary, the parking actions of the respective autonomous vehicles to meet a portion of the intentions of the autonomous vehicles collaboration manager 152/252 to position the vehicles as compactly as possible while providing the occupants the best scenario for passage to and from the vehicles given the existing real world conditions. The augmented reality features of the autonomous vehicles collaboration manager 152/252 facilitates the latter. For example, and without limitation, the artificial intelligence platform 150 facilitates the latter through leveraging the augmented reality features of the autonomous vehicles collaboration manager 152/252 to provide the best mode for passage of the occupants for the given conditions. In some embodiments, the autonomous vehicles collaboration manager 152/252 facilitates the former through allowing occupants to offload in one location and to move the vehicle to the parking position with only the driver, or, in some cases, completely autonomously with no human interaction.

It is noted that in many cases the parking facility may be covered, thereby minimizing the impact of inclement weather conditions beyond the entrance to the parking facility; however, in contrast, some parking facilities are not completely enclosed and are thereby subject to snow drifts, horizontal rain, high winds, high/low temperatures, and the like. In at least some embodiments, the models of the autonomous vehicles collaboration manager 152/252 are trained to mitigate the impact of substantially all inclement weather conditions associated with a myriad of parking facilities and scenarios. Accordingly, in at least some embodiments, the historical weather conditions data 177 is used to train the models in the models retaining modules 166, through the models learning modules 165 (both embedded in the modeling engine 164). Such historical weather conditions data 177 is used to leverage previous actions executed as a function of weather conditions in collaboration with the real time weather conditions as captured through the information handling devices 180.

The historical traffic conditions data 178 includes, without limitation, those traffic conditions conducive to executing the operations of the vehicular information system 100, including the autonomous vehicles collaboration manager 152/252 and the engines embedded therein. In addition, the historical traffic conditions data 178 includes, without limitation, those traffic conditions unfavorable to executing the operations of the vehicular information system 100, including the autonomous vehicles collaboration manager 152/252 and the engines embedded therein. For example, and without limitation, unfavorable traffic conditions leading to, or within, a parking facility will necessarily induce the trained models in the artificial intelligence platform 150 to alter, as necessary, the parking actions of the respective autonomous vehicles to meet a portion of the intentions of the autonomous vehicles collaboration manager 152/252 to position the vehicles as compactly as possible while providing the occupants the best scenario for passage to and from the vehicles given the existing real world conditions. The augmented reality features of the autonomous vehicles collaboration manager 152/252 facilitates the latter. For example, and without limitation, the artificial intelligence platform 150 facilitates the latter through leveraging the augmented reality features of the autonomous vehicles collaboration manager 152/252 to provide the best mode for passage of the occupants for the given conditions. In some embodiments, the autonomous vehicles collaboration manager 152/252 facilitates the former through allowing occupants to offload in one location and to move the vehicle to the parking position with only the driver, or, in some cases, completely autonomously with no human interaction.

Accordingly, in at least some embodiments, the historical traffic conditions data 178 is used to train the models in the models retaining modules 166, through the models learning modules 165 (both embedded in the modeling engine 164). Such historical traffic conditions data 178 is used to leverage previous actions executed as a function of traffic conditions in collaboration with the real time traffic conditions as captured through the information handling devices 180.

The historical road conditions data 179 includes, without limitation, those road conditions conducive to executing the operations of the vehicular information system 100, including the autonomous vehicles collaboration manager 152/252 and the engines embedded therein. In addition, the historical road conditions data 179 includes, without limitation, those road conditions unfavorable to executing the operations of the vehicular information system 100, including the autonomous vehicles collaboration manager 152/252 and the engines embedded therein. For example, and without limitation, unfavorable road conditions leading to a parking facility will necessarily induce the trained models in the artificial intelligence platform 150 to alter, as necessary, the parking actions of the respective autonomous vehicles to meet the intentions of the autonomous vehicles collaboration manager 152/252 to position the vehicles as compactly as possible while providing the occupants the best scenario for passage to and from the vehicles given the existing real world conditions. The augmented reality features of the autonomous vehicles collaboration manager 152/252 facilitates the former. For example, and without limitation, the artificial intelligence platform 150 facilitates the former through leveraging the augmented reality features of the autonomous vehicles collaboration manager 152/252 to provide the best mode for accessing the parking facility, or, in some circumstances, to select another parking facility.

Accordingly, in at least some embodiments, the historical road conditions data 179 is used to train the models in the models retaining modules 166, through the models learning modules 165 (both embedded in the modeling engine 164). Such historical road conditions data 179 is used to leverage previous actions executed as a function of road conditions in collaboration with the real time road conditions as captured through the information handling devices 180.

In addition, the AR engine 153/253 with the AR real time tracking module 154 embedded therein facilitates one or more occupant-centric functions that include, without limitation, tracking the real time offboarding and/or onboarding information of the occupants from the vehicle and identifying which occupants are no longer required to be unloaded or loaded. These features are in addition to the features described above for augmenting real time access to, traversal of, parking within, and occupant passage through, the parking facilities.

Moreover, the AR engine 153/253 with the AR real time tracking module 154 embedded therein facilitates one or more occupant-centric functions that include, without limitation, intercommunications between the autonomous vehicles with respect to the respective occupants' mobility paths in the surroundings of the respective vicinities of the respective vehicles with AR glasses/goggles 180-8-based guidance so that the occupants can safely and expeditiously exit, transit from, transit toward, and enter the respective vehicles. In some embodiments, the AR engine 153/253 provides the occupant AR-based guidance as a first person view (FPV) through the AR glasses/goggles 180-8 worn by one or more of the respective occupants. In some embodiments, the AR engine 153/253 facilitates collaboration between the respective vehicle and other nearby vehicles, as well as the AR devices of the occupants through their AR glasses/goggles 180-8, mobile phones 180-1, and tablets 180-3 to generate an AR overlay. This AR overlay is used to identify if the occupants from multiple vehicles need to be dropped off at the same location, including prior to the designated destination. Also, this AR overlay facilitates further guiding the occupants through a best mode occupant pathway to transit from and transit to the vehicle as appropriate, including which doors should remain closed/locked to prevent any door collisions, etc. In some embodiments, AR engine 153/253 proactively guides the occupants to optimum positions for onboarding either a particular vehicle, or any other vehicle, if the occupants are heading toward the same stop to facilitate the designated door-opening scheme to minimize a potential for contact between the doors of adjacent vehicles and presenting an obstruction to exiting occupants. In some embodiments, the AR engine 153/253 uses the known geographic and environmental attributes data 173, the known occupant attributes data 175, and the historical vehicle placement and space utilization data 176 as previously described. In addition, the AR engine 153/253 facilitates the maintenance of the real time number of occupants in the plurality of autonomous vehicles and the historical data for the occupants, i.e., the known occupant attributes data 175.

Furthermore, the AR engine 153/253 facilitates one or more occupant-centric functions, and more specifically, one or more driver/operator-centric functions that include, without limitation, using additional vehicular AR-based guidance in the form of an overhead view display of the respective vehicle including virtual objects configured to guide the respective vehicle to the occupant offboarding location. The AR-generated overhead display provides additional guidance to the driver of the respective vehicle to park in the determined location through one or more of virtual lines, virtual arrows, textual directions, and the like.

In some embodiments, the AR engine 153/253 includes features that facilitate the occupants using the AR features to directly opt-in/op-out for privacy purposes.

The known occupant attributes data 175 includes those occupant attributes conducive to executing the operations of the vehicular information system 100, including the autonomous vehicles collaboration manager 152/252 and the engines embedded therein. Such known occupant attributes data 175 include, for example, and without limitation, height, weight, any special mobility issues, and the other attributes that will necessarily induce the trained models in the artificial intelligence platform 150 to alter, as necessary, the parking actions of the respective autonomous vehicles to meet a portion of the intentions of the autonomous vehicles collaboration manager 152/252 to position the vehicles as compactly as possible while providing the occupants the best scenario for passage to and from the vehicles given the existing real world conditions. The augmented reality features of the autonomous vehicles collaboration manager 152/252 facilitates the latter. For example, and without limitation, the artificial intelligence platform 150 facilitates the latter through leveraging the communication features through the autonomous vehicles collaboration manager 152/252 to provide the best mode for identifying a parking space in the vicinity of the passage that best suits a person requiring the use of a wheelchair.

Accordingly, in at least some embodiments, the known occupant attributes data 175 are used to train the models in the models retaining modules 166, through the models learning modules 165 (both embedded in the modeling engine 164). Such known occupant attributes data 175 are used to leverage previous actions executed as a function of known occupant attributes.

In some embodiments, the autonomous vehicles collaboration manager 152/252 that collects and uses the known occupant attributes data 175 includes features that facilitate the occupants to directly opt-in/opt-out for privacy purposes.

The vehicle movement and position engine 156/256, that includes the offboarding vehicle movement and position planning module 157, and the onboarding vehicle movement and position planning module 158 embedded therein facilitates one or more vehicle-centric functions that include, without limitation, each autonomous vehicle collaborating with each other with respect to identifying the respective vehicular door specifications, including, without limitation, the range of opening angles of the doors with respect to offboarding and onboarding occupants. In some embodiments, the vehicle movement and position engine 156/256 uses the known vehicular attributes data 174, and the historical vehicle placement and space utilization data 176. In some embodiments, the vehicle movement and position engine 156/256 is used for identifying that the respective vehicle is one of fully-autonomous, semi-autonomous, or non-autonomous and is approaching a parking area. In addition, in some embodiments, the vehicle movement and position engine 156/256 is used for determining, through one or more of a set of sensors, for example, and without limitation, cameras (i.e., IoT devices 180-7) and AR-based vision enhancements (i.e., the AT goggles/glasses 180-8), the locations of other vehicles within the parking area, regardless of the level of autonomy such other vehicles have. Therefore, based on the collaboration of the vehicles, the dimensions of each vehicle are identified so that the vehicular dimensions, for example, and without limitation, are considered for creating optimized passage for the offboarding and onboarding occupants. Accordingly, such collaboration facilitates determining a location to park the vehicle, including an angle, direction, and physical position of the vehicle at least partially based on the calculated locations of the other vehicles within the vicinity of the parking or stopping area.

In addition, the vehicle movement and position engine 156/256 facilitates one or more occupant-centric functions that include, without limitation, identifying which occupants need to exit/enter the vehicle at the destination, including those multiple occupants that will also be offboarding/onboarding in the same place within an established timeframe. Furthermore, the vehicle movement and position engine 156/256 additionally facilitates occupant-centric functions that include identifying the total number of occupants from the total number of vehicles that will be either offboarding or onboarding at the designated location, including the number and identities of the vehicles that are lined up or are otherwise being directed to the proximate area of loading and offloading. Also, the vehicle movement and position engine 156/256 facilitates occupant-centric functions that include identifying for each vehicle the occupants' profiles and the present, or intended, occupants' positions in the vehicle to identify if the occupants can offboard or onboard from one side of the vehicle or the other side. In some embodiments, the vehicle movement and position engine 156/256 uses the known occupant attributes data 175.

Moreover, the vehicle movement and position engine 156/256 facilitates one or more vehicle-centric functions that include, without limitation, the vehicles in the vicinity of the offboarding point collaborating with each other via the surrounding IoT ecosystem through, for example, and without limitation, the IoT devices 180-7, to identify the appropriate available space in the parking surroundings for the vehicle to stop. Such IoT devices 180-7 may include the previously discussed parking facility cameras, as well as vehicle-mounted cameras.

Further, the vehicle movement and position engine 156/256 facilitates assigning the appropriate parking space such that the occupants that need to be offboarded or onboarded are provided with the optimum surroundings to provide optimum passage. This feature includes using the determined passage to and from the vehicle to identify which doors of the vehicles can be opened to avoid interference with adjacent vehicles and avoid creating any obstacles to passage of the occupants, and which doors of the vehicle are to remained closed, including identifying which vehicle can open doors on both sides to allow the occupants to exit and enter the respective vehicles more expeditiously.

The space reduction engine 160/260, that includes the space utilization module 161 embedded therein, facilitates one or more vehicle-centric functions that include, without limitation, each autonomous vehicle collaborating with each other with respect to identifying the respective vehicular door specifications, including, without limitation, the range of opening angles of the doors with respect to offboarding and onboarding occupants. In some embodiments, the space reduction engine 160/260 uses the known vehicular attributes data 174, and the historical vehicle placement and space utilization data 176. Accordingly, based on the collaboration of the vehicles, the dimensions of each vehicle are identified so that the vehicular dimensions, for example, and without limitation are considered for creating optimized passage for the offboarding and onboarding occupants. In addition, the space reduction engine 160/260 facilitates one or more occupant-centric functions that include, without limitation, identifying which occupants need to exit/enter the vehicle at the destination, including those multiple occupants that will also be offboarding/onboarding in the same place within an established timeframe.

Moreover, the space reduction engine 160/260 facilitates one or more vehicle-centric functions that include, without limitation, the vehicles in the vicinity of the offboarding point collaborating with each other via the surrounding IoT ecosystem through, for example, and without limitation, the IoT devices 180-7, to identify the appropriate available space in the parking surroundings for the vehicle to stop.

The space reduction engine 160/260 facilitates one or more vehicle-centric functions that include, without limitation, the respective autonomous vehicles analyzing the surrounding vicinity and identifying how the autonomous vehicles are to be placed to position the optimum number of vehicles in the designated area constraints. In some embodiments, the space reduction engine 160/260 uses the known geographic and environmental attributes data 173, the known vehicular attributes data 174, and the historical vehicle placement and space utilization data 176. Also, in some embodiments, the historical weather conditions data 177, the historical traffic conditions data 178, and the historical road conditions data 179 are also used if necessary as a function of the location of offboarding and onboarding of occupants.

Further, the space reduction engine 160/260 facilitates assigning the appropriate parking space such that the occupants that need to be offboarded or onboarded are provided with the optimum surroundings to provide optimum passage. This feature includes using the determined passage to and from the vehicle to identify which doors of the vehicles can be opened to avoid interference with adjacent vehicles and avoid creating any obstacles to passage of the occupants, and which doors of the vehicle are to remained closed, including identifying which vehicle can open doors on both sides to allow the occupants to exit and enter the respective vehicles more expeditiously.

The occupant walking pathway highlighting engine 162/262, that includes the logical autonomous vehicle door path planning module 163 embedded therein, facilitates one or more vehicle-centric functions that include, without limitation, each autonomous vehicle collaborating with each other with respect to identifying the respective vehicular door specifications, including, without limitation, the range of opening angles of the doors with respect to offboarding and onboarding occupants. In some embodiments, the occupant walking pathway highlighting engine 162/262 uses the known vehicular attributes data 174, and the historical vehicle placement and space utilization data 176. Accordingly, based on the collaboration of the vehicles, the dimensions of each vehicle are identified so that the vehicular dimensions, for example, and without limitation are considered for creating optimized passage for the offboarding and onboarding occupants. In addition, occupant walking pathway highlighting engine 162/262 facilitates one or more occupant-centric functions that include, without limitation, identifying which occupants need to exit/enter the vehicle at the destination, including those multiple occupants that will also be offboarding/onboarding in the same place within an established timeframe.

Further, the occupant walking pathway highlighting engine 162/262 facilitates assigning the appropriate parking space such that the occupants that need to be offboarded or onboarded are provided with the optimum surroundings to provide optimum passage. This feature includes using the determined passage to and from the vehicle to identify which doors of the vehicles can be opened to avoid interference with adjacent vehicles and avoid creating any obstacles to passage of the occupants, and which doors of the vehicle are to remain closed, including identifying which vehicle can open doors on both sides to allow the occupants to exit and enter the respective vehicles more expeditiously.

In addition, the occupant walking pathway highlighting engine 162/262 facilitates one or more occupant-centric functions that include, without limitation, tracking the real time offboarding and/or onboarding information of the occupants from the vehicle and identifying which occupants are no longer required to be unloaded or loaded. These features are in addition to the features described above for augmenting real time access to, traversal of, parking within, and occupant passage through the parking facilities.

Moreover, the occupant walking pathway highlighting engine 162/262 facilitates one or more occupant-centric functions that include, without limitation, intercommunications between the autonomous vehicles with respect to the respective occupants' mobility paths in the surroundings of the respective vicinities of the respective vehicles with AR glasses/goggles 180-8-based guidance so that the occupants can safely and expeditiously exit and enter the respective vehicles. In some embodiments, the occupant walking pathway highlighting engine 162/262 uses the known geographic and environmental attributes data 173, the known occupant attributes data 175, and the historical vehicle placement and space utilization data 176 as previously described. In addition, the occupant walking pathway highlighting engine 162/262 facilitates the maintenance of the real time number of occupants in the plurality of autonomous vehicles and the historical data for the occupants, i.e., the known occupant attributes data 175.

The modeling engine 164, including the models learning modules 165 and the embedded models module 166 that includes, without limitation, the models resident therein, facilitates initial and continuous training of the models with the data resident within at least a portion of the historical/training database 172.

In one or more embodiments, the AR engine 153/253, the vehicle movement and position engine 156/256, the space reduction engine 160/260, and the occupant walking pathway highlighting engine 162/262, including their respective modules, overlap with respect to the functionalities, as defined for each herein, for the autonomous vehicles collaboration manager 152/252. In some embodiments, the functionalities are apportioned to a particular engine with substantially no overlap of the functionalities between the engines. In some embodiments, any embedding of the plurality of functions within the autonomous vehicles collaboration manager 152/252 that enables operation thereof is implemented.

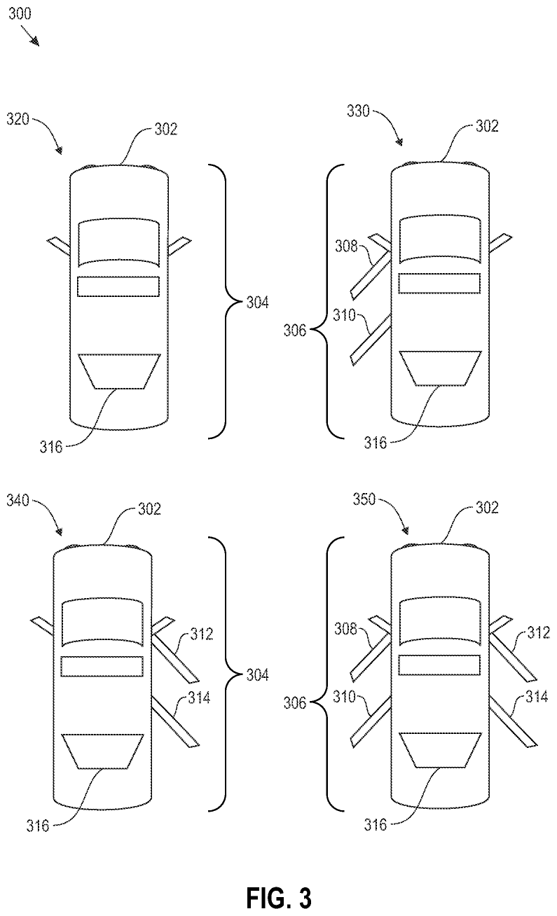

Referring to FIG. 3, a schematic diagram is presented illustrating an autonomous vehicle 302 in a plurality 300 of onboarding/offboarding configurations 320, 330, 340, and 350, that may be used in conjunction with the system 100 shown in FIGS. 1A-2, in accordance with some embodiments of the present disclosure. The autonomous vehicle 302 includes a driver's side 304 and a passenger side 306. The driver's side 304 of the autonomous vehicle 302 includes a driver's side front door 308 and a driver's side rear door 310. In some embodiments of the autonomous vehicle 302, only a driver's side front door 308 is present. The passenger side 306 of the autonomous vehicle 302 includes a passenger side front door 312 and a passenger side rear door 314. In some embodiments of the autonomous vehicle 302, only a passenger side front door 312 is present. In some embodiments, the autonomous vehicle 302 includes a hatchback door 316. In the embodiments illustrated herein, the autonomous vehicle 302 is a four-door hatchback vehicle. In some embodiments, the autonomous vehicle is a two-door vehicle, with or without the hatchback features. In some embodiments, the autonomous vehicle is any vehicle configured to employ the system 100 as described herein, including, without limitation, a truck, bus, or a van.

The first configuration is a closed-door configuration 320 that is provided to illustrate the autonomous vehicle 302 in the configuration that it is most likely to be viewed when being driven or once parked and empty of occupants. The second configuration 330 of the autonomous vehicle 302 shows the driver's side front door 308 and the driver's side rear door 310 open for occupants, including the driver, to offboard and onboard the vehicle 302. In some embodiments, only one of the two doors 308 and 310 will need to be opened. The third configuration 340 of the autonomous vehicle 302 shows the passenger side front door 312 and the passenger side rear door 314 open for occupants, including the driver, to offboard and onboard the vehicle 302. In some embodiments, only one of the two doors 312 and 314 will need to be opened. It is noted that in the second configuration 330 and the third configuration 340 of the autonomous vehicle 302 that the occupants, including the driver, may need to enter and exit the vehicle 302 on the opposite side of the vehicle 302 where their seat resides, and the system 100 will have the necessary vehicle configuration information to select the parking position for the vehicle 302 that allows occupant ingress and egress without excessive discomfort. In addition, in some embodiments, the system 100 uses the hatchback door 316 for ingress and egress. Furthermore, in some embodiments, the system 100 uses the specific configurations of vans, buses, trucks, and specialized vehicles to facilitate parking, ingress, and egress.

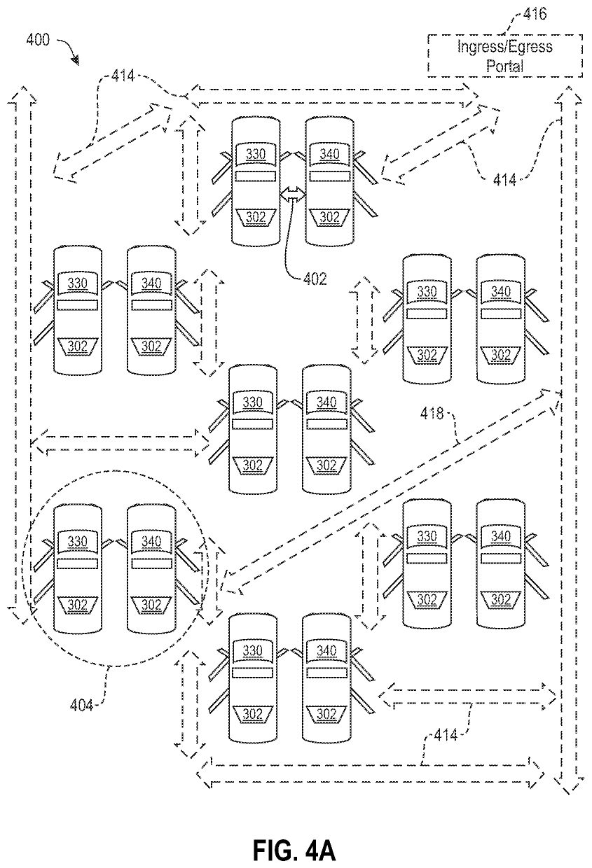

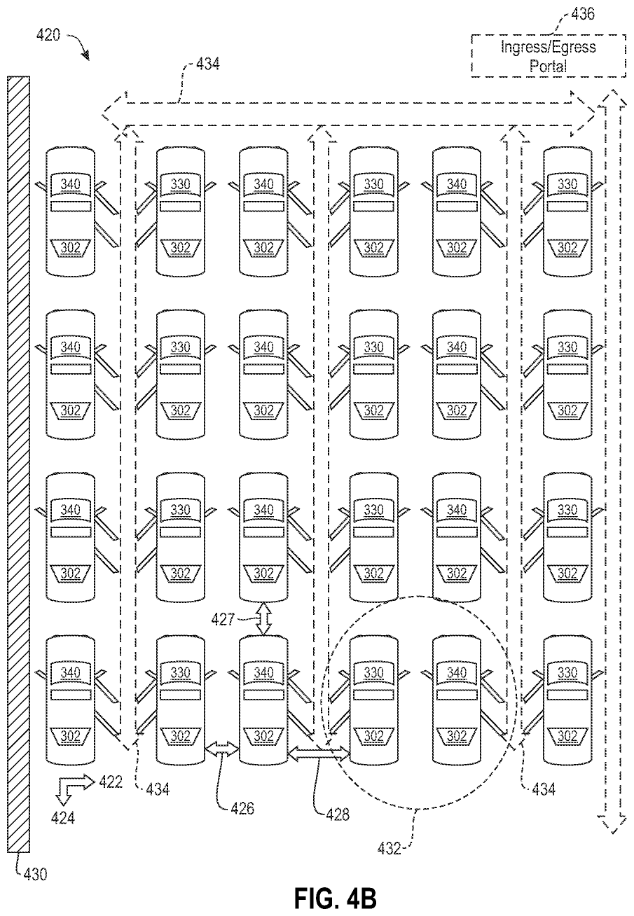

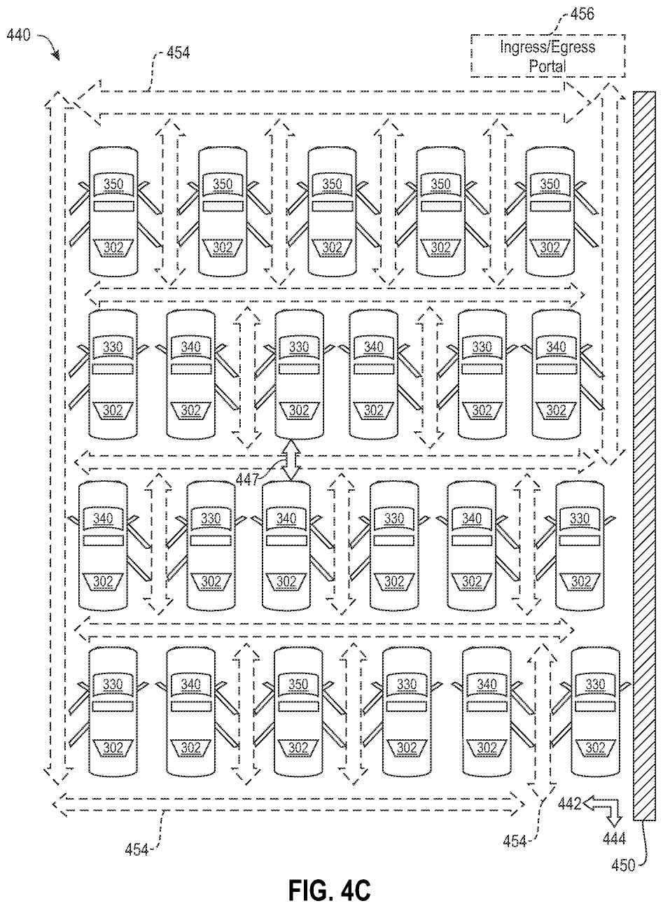

Referring to FIG. 4A, a schematic diagram is presented illustrating one possible parking configuration 400 for a plurality of autonomous vehicles 302 (as shown in FIG. 3) using the system 100 (as shown and described with respect to FIGS. 1A-2), in accordance with some embodiments of the present disclosure. Also, referring to FIG. 3, the vehicles 302 are arranged in one possible configuration 400 that facilitates the position and orientation of the vehicles 302 to be stopped to optimize the number of occupants that can exit and enter the vehicles 302 as well as optimize the total number of vehicles 302 that are to be parked at the same time in the designated parking vicinities. Specifically, the vehicles 302 are arranged such that the doors directly opposing another vehicle 302 are not to be opened, where a spacing 402 (only one shown) between vehicles 302 is optimized. Therefore, the parking configuration 400 defines a plurality of pairs 404 (only one labeled) of autonomous vehicles 302, where the doors of directly adjacent vehicles 302 do not open. In some embodiments, the spacing 402 is less than shown (e.g., see FIGS. 4B and 4C of this disclosure); however, the potential for one vehicle 302 damaging an adjacent vehicle 302 is minimized through the system 100 not positioning the vehicles 302 at less than an established minimum value for spacing 402.

In addition, passage 414 (not all labeled) for the occupants to and from the respective vehicles 302 with respect to an ingress/egress portal 416 are highlighted for the occupants through the respective AR goggles/glasses 180-8 (see FIG. 1A). Also, in at least some embodiments, the parking configuration 400 provides multiple paths, e.g. passage 418 (only one shown), for the occupants for transit to and from the respective vehicles 302 with respect to the ingress/egress portal 416. In some embodiments, the ingress/egress portal 416 is one or more of one or more doors, elevators, turnstiles, escalators, moving walkways, passageways, bus/trolley/transport van stop, and the like.

In some embodiments, the parking configuration 400 illustrates a trade-off between optimizing the total number of vehicles 302 to a particular area and optimizing the number of occupants that can exit and enter the vehicles 302 (with assistance from the AR engine 153 (see FIG. 1B)). Specifically, as shown in FIGS. 4B and 4C of this disclosure, the density of the vehicles 302 may be made greater for the particular parking area as compared to that shown in FIG. 4A.

Referring to FIG. 4B, a schematic diagram is presented illustrating one possible parking configuration 420 for a plurality of autonomous vehicles 302 (as shown in FIG. 3) using the system 100 (as shown and described with respect to FIGS. 1A-2), in accordance with some embodiments of the present disclosure. Also referring to FIG. 3, the vehicles 302 are arranged in one possible configuration 420 that facilitates the position and orientation of the vehicles 302 to be stopped to optimize the number of occupants that can exit and enter the vehicles 302 as well as optimize the total number of vehicles 302 that are to be parked at the same time in the designated parking vicinities.

Specifically, the vehicles 302 are arranged in a plurality of parallel horizontal rows 422 and vertical rows 424, where the rows 422 and 424 are perpendicular to each other, and where a first spacing 426 (only one shown), a second spacing 427, and a third spacing 428 (only one shown) between vehicles 302 are optimized. The parking configuration 420 includes a wall 430 against which the left-most vertical row 424 of vehicles 302 is positioned such that only the third configuration 340 of the autonomous vehicle 302 that allows the passenger side front door 312 and the passenger side rear door 314 to be open for the occupants, including the driver, to offboard and onboard the vehicle 302, while the driver's side front door 308 and the driver's side rear door 310 are not to be opened. The next four vertical rows 424 includes a plurality of vehicles 302 arranged in alternating vertical rows 424 of the second configuration 330 and the third configuration 340 of the autonomous vehicles 302 to define a plurality of pairs 432 (only one shown) similar to the pair 404 (shown in FIG. 4A). The sixth vertical row 424 includes the vehicles 302 in the second configuration 330. In some embodiments, the spacings 426, 427, and 428 are less than shown in FIG. 4B; however, the potential for one vehicle 302 damaging an adjacent vehicle 302 is minimized through the system 100 not positioning the vehicles 302 at less than established minimum values for spacings 426, 427, and 428, respectively.

In addition, passage 434 (not all labeled) for the occupants to and from the respective vehicles 302 with respect to an ingress/egress portal 436 are highlighted for the occupants through the respective AR goggles/glasses 180-8 (see FIG. 1A). Also, in at least some embodiments, the parking configuration 420 provides little in the way of options for the passage 434 from the respective vehicles 302 with respect to the ingress/egress portal 436. In some embodiments, the ingress/egress portal 436 is one or more of one or more doors, elevators, turnstiles, escalators, moving walkways, passageways, bus/trolley/transport van stop, and the like.

In some embodiments, the parking configuration 420 illustrates a trade-off between optimizing the total number of vehicles 302 to a particular area and optimizing the number of occupants that can exit and enter the vehicles 302 (with assistance from the AR engine 153). Specifically, as shown in FIG. 4B, the density of the vehicles 302 may be made greater for the particular parking area as compared to that shown in FIG. 4A of this disclosure.

Referring to FIG. 4C, a schematic diagram is presented illustrating one possible parking configuration 440 for a plurality of autonomous vehicles 302 (as shown in FIG. 3) using the system 100 (as shown and described with respect to FIGS. 1A-2), in accordance with some embodiments of the present disclosure. Also referring to FIG. 3, the vehicles 302 are arranged in one possible configuration 440 that facilitates the position and orientation of the vehicles 302 to be stopped to optimize the number of occupants that can exit and enter the vehicles 302 as well as optimize the total number of vehicles 302 that are to be parked at the same time in the designated parking vicinities.

Specifically, the vehicles 302 are arranged in a plurality of parallel horizontal rows 442 and a plurality of partial vertical rows 444, where the rows 442 and 444 are perpendicular to each other, and where a variety of first spacings (not labeled) between vehicles 302 are shown within each horizontal row 442 and a vertical spacing 447 (only one shown) between the horizontal rows 442 are substantially similar to facilitate defining passage 454 therethrough, such that the positioning of the vehicles 302 is optimized. The parking configuration 440 includes a wall 450 against which some of the right-most vehicles 302 un the lower two horizontal rows 442 are positioned such that only the second configuration 330 of the autonomous vehicle 302 that allows the driver's side front door 308 and the driver's side rear door 310 to be open for the occupants, including the driver, to offboard and onboard the vehicle 302, while the passenger side front door 312 and the passenger side rear door 314 are not to be opened.

The uppermost horizontal row 442 includes only five vehicles 302 with the fourth configuration 350, where all four car doors are allowed to be open. The next two horizontal rows 442 both include an arrangement of vehicles 302 with the second configuration 330 and the third configuration 340; however, the sequence of the vehicles 302 left-to-right differ. Such alternating the configurations facilitates defining the respective passages 454. The lowermost horizontal row 442 includes a combination of vehicles 302 with the second configuration 330, the third configuration 340, and the fourth configuration 350, where the vehicle 302 with the fourth configuration 350 was includes to facilitate offboarding and onboarding of one or more occupants therein, and the remainder of the vehicles 302 were placed to take advantage of the vehicles 302 are further configured to have either one of the second configuration 330 and the third configuration 340.

In addition, passage 454 (not all labeled) for the occupants to and from the respective vehicles 302 with respect to an ingress/egress portal 456 are highlighted for the occupants through the respective AR goggles/glasses 180-8 (see FIG. 1A). Also, in at least some embodiments, the parking configuration 440 provides more in the way of options for the passage 454 from the respective vehicles 302 with respect to the ingress/egress portal 456 that the configuration 420 (see FIG. 4B). In some embodiments, the ingress/egress portal 436 is one or more of one or more doors, elevators, turnstiles, escalators, moving walkways, passageways, bus/trolley/transport van stop, and the like.

In some embodiments, the parking configuration 440 illustrates a trade-off between optimizing the total number of vehicles 302 to a particular area and optimizing the number of occupants that can exit and enter the vehicles 302 (with assistance from the AR engine 153).

Accordingly, the system as described herein, including the autonomous vehicles collaboration manager 152, is configured to position one or more groups of autonomous vehicles of any configuration to use the available parking area most efficiently while providing the occupants with sufficient room to transit to and from their respective vehicles represented with AR support. The orientations of the vehicles need no be according to an X-Y grid as described herein with respect to FIGS. 4A-4C, and any parking facility configurations may be used, including multi-level and multi-location parking facilities.

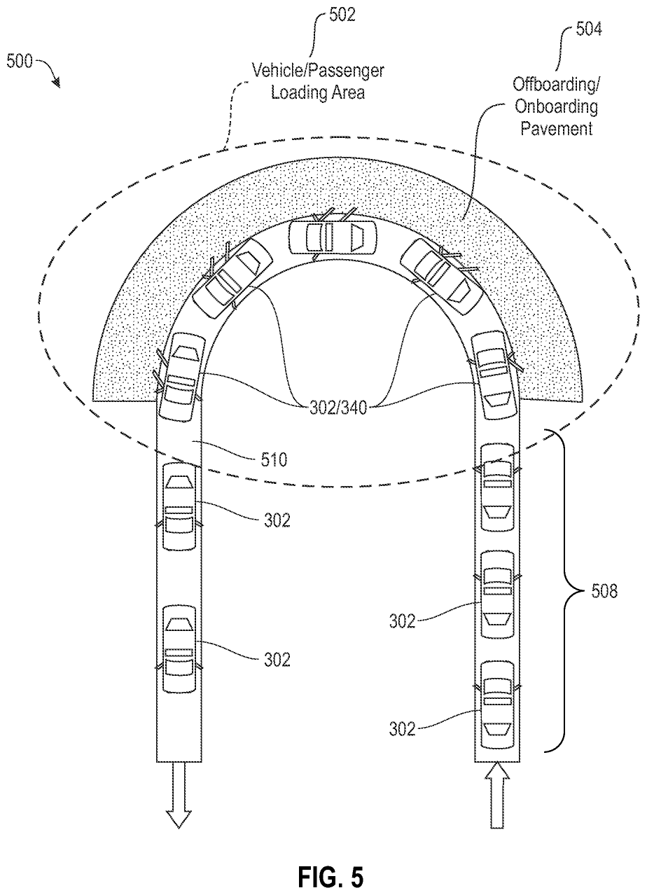

Referring to FIG. 5, a schematic diagram is presented illustrating one possible occupant offboarding and onboarding configuration 500 for a plurality of autonomous vehicles 302 (as shown in FIG. 3) using the system 100 (as shown and described with respect to FIGS. 1A-2), in accordance with some embodiments of the present disclosure. As previously described, the system 100 leverages optimization techniques to ensure that for those instances where a minimum space utilization for stopped vehicles to offboard and onboard, a maximum number of occupants can exit or enter their respective vehicles at an area such as, and without limitation, airports, hospitals, schools, event venues, and the like. Accordingly, FIG. 5 shows one embodiment of a vehicle/passenger loading area 502 that includes an occupant offboarding/onboarding pavement 504. The occupant offboarding and onboarding configuration 500 includes one or more vehicular approach lanes 506 that are configured to accommodate a string of vehicles 508. As shown, the vehicles 302 are in the third configuration 340 at the occupant offboarding/onboarding pavement 504. However, the system 100 is configured to accommodate any occupant offboarding and onboarding configuration.

In at least some embodiments, the vehicle movement and position engine 156/256 (see FIGS. 1B and 2) facilitates one or more occupant-centric functions that include, without limitation, identifying which occupants need to exit/enter the vehicle 302 at the destination, including those multiple occupants that will also be offboarding/onboarding in the same place within an established timeframe. Furthermore, the vehicle movement and position engine 156/256 additionally facilitates occupant-centric functions that include identifying the total number of occupants from the total number of vehicles 302 that will be either offboarding or onboarding at the designated location, including the number and identities of each of the vehicles 302 (and their occupants) that are lined up as string of vehicles 508 in the vehicular approach lane 506. For those embodiments that are configured to accommodate the second configuration 320 and the fourth configuration 350 (see FIG. 3) as well as the third configuration 340, the vehicle movement and position engine 156/256 facilitates occupant-centric functions that include identifying for each vehicle the occupants' profiles and the present, or intended, occupants' positions in the vehicle to identify if the occupants can offboard or onboard from one side of the vehicle 302 or the other side.

Moreover, in at least some embodiments, the vehicle movement and position engine 156/256 facilitates one or more vehicle-centric functions that include, without limitation, the vehicles 302 in the vicinity of the vehicle/passenger loading area 502 collaborating with each other via a surrounding IoT ecosystem through, for example, and without limitation, the IoT devices 180-7, to identify the appropriate available space at the offboarding/onboarding pavement 504 for the respective vehicles 302 to stop. Such IoT devices 180-7 may include the previously discussed cameras at the vehicle/passenger loading area 502, as well as any vehicle-mounted cameras. In some embodiments, these features are executed in conjunction with the space reduction engine 160/260 (see FIGS. 1B and 2).

In one or more embodiments, the space reduction engine 160/260 (see FIGS. 1B and 2) facilitates one or more vehicle-centric functions that include, without limitation, each autonomous vehicle 302 collaborating with each other with respect to sharing the dimensions of each vehicle 302 to identify respective the vehicular dimensions to facilitate creating optimized passage for the offboarding and onboarding occupants. In addition, the space reduction engine 160/260 facilitates one or more occupant-centric functions that include, without limitation, identifying which occupants need to exit/enter the vehicle 302 at the vehicle/passenger loading area 502, including those multiple occupants that will also be offboarding/onboarding in the same place within an established timeframe.

Furthermore, in one or more embodiments, the AR engine 153/253 (see FIGS. 1B and 2) facilitates one or more occupant-centric functions, and more specifically, one or more driver/operator-centric functions that include, without limitation, using additional vehicular AR-based guidance in the form of an overhead view display of the respective vehicle 302 including virtual objects configured to guide the respective vehicle 302 to the offboarding/onboarding pavement 504. The AR-generated overhead display provides additional guidance to the driver of the respective vehicle 302 to stop at a specific portion of the offboarding/onboarding pavement 504 through one or more of virtual lines, virtual arrows, textual directions, and the like.

Moreover, in one or more embodiments, the AR engine 153/253 facilitates one or more occupant-centric functions that include, without limitation, intercommunications between the autonomous vehicles 302 with respect to the respective occupants' mobility paths in the surroundings of the respective vicinities of the respective vehicles with AR glasses/goggles 180-8-based guidance so that the occupants can safely and expeditiously exit, transit from, transit toward, and enter the respective vehicle 302 at the offboarding/onboarding pavement 504. In some embodiments, the AR engine 153/253 provides the occupant AR-based guidance as a first person view (FPV) through the AR glasses/goggles 180-8 worn by one or more of the respective occupants. In some embodiments, the AR engine 153/253 facilitates collaboration between the respective vehicle and other nearby vehicles, as well as the AR devices of the occupants through their AR glasses/goggles 180-8, mobile phones 180-1, and tablets 180-3 to generate an AR overlay. This AR overlay is used to identify if the occupants from multiple vehicles need to be dropped off at the same location, including prior to the designated destination. Also, this AR overlay facilitates further guiding the occupants through a best mode occupant pathway to transit from and transit to the vehicle 302 through the vehicle/passenger loading area 502 as appropriate, including which doors should remain closed/locked to prevent inadvertent exit from the vehicle 302 on the wrong side of the respective vehicle 302.

In addition, in at least some embodiments, the autonomous vehicles collaboration manager 152/252 (see FIGS. 1A, 1B, and 2) determines those traffic conditions unfavorable to executing the operations of the vehicular information system 100, for example, and without limitation, inclement weather and unfavorable traffic conditions leading to, or within, the vehicle/passenger loading area 502 that will necessarily induce the trained models in the artificial intelligence platform 150 to alter, as necessary, the approach and parking actions of the respective autonomous vehicles 302 to meet a portion of the intentions of the autonomous vehicles collaboration manager 152/252 to position the vehicles 302 as effectively and efficiently as possible while providing the occupants the best scenario for passage to and from the vehicles 302 given the existing real world conditions. The augmented reality features of the autonomous vehicles collaboration manager 152/252 facilitates the latter. For example, and without limitation, the artificial intelligence platform 150 facilitates the latter through leveraging the augmented reality features of the autonomous vehicles collaboration manager 152/252 to provide the best mode for passage of the occupants for the given conditions. In some embodiments, the autonomous vehicles collaboration manager 152/252 facilitates the former through allowing the occupants to offload in one location and to move the vehicle 302 to a parking position with only the driver, or, in some cases, completely autonomously with no human interaction. Regardless of the level of autonomy, the vehicles 302 that have offboarded or onboarded the occupants will leave the offboarding/onboarding pavement 504 via an exit lane 510.

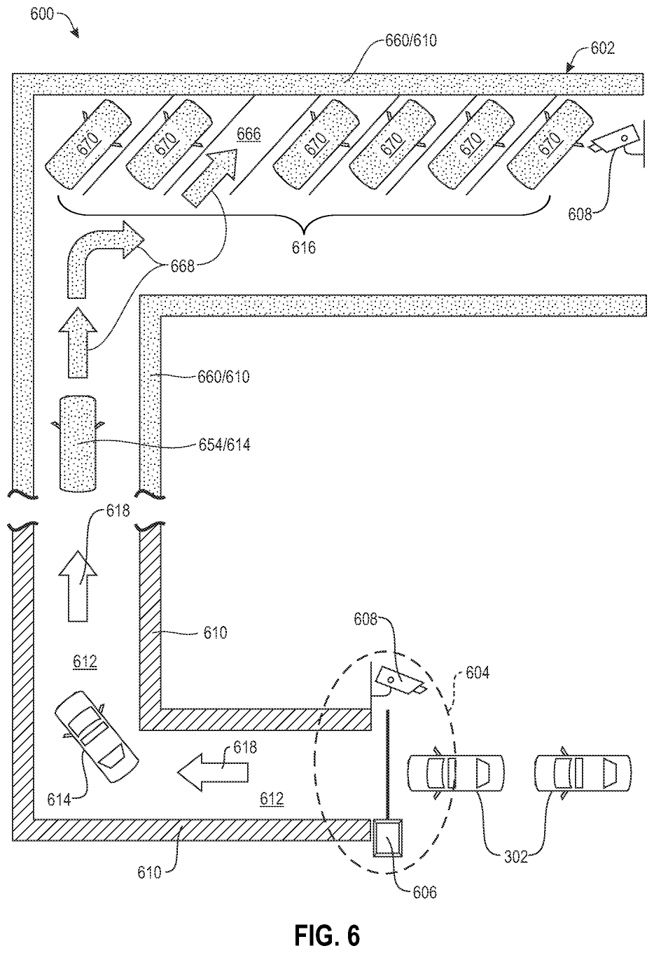

Referring to FIG. 6, a schematic diagram is presented illustrating one possible augmented reality assist 600 for a driver of a vehicle similar to the autonomous vehicles 302 (as shown in FIG. 3) using the system 100 (as shown and described with respect to FIGS. 1A-2), in accordance with some embodiments of the present disclosure. As previously described, in at least some embodiments, the AR engine 153/253 facilitates one or more occupant-centric functions, and more specifically, one or more driver/operator-centric functions that include, without limitation, using additional vehicular AR-based guidance in the form of an overhead view display of the respective vehicle 302 including virtual objects configured to guide the respective vehicle 302 to the occupant offboarding location. The AR-generated overhead display provides additional guidance to the driver of the respective vehicle to park in the determined location through one or more of virtual lines, virtual arrows, textual directions, and the like. In some embodiments, the artificial intelligence platform 150 facilitates leveraging the augmented reality features of the autonomous vehicles collaboration manager 152/252 to provide the best mode for accessing a parking facility 602, or, in some circumstances, to select another parking facility.

In at least some embodiments, the parking facility 602 includes an entrance 604 that includes a gate mechanism 606 and at least one camera 608. The parking facility 602 also includes one or more walls 610 that define a path 612 to guide a transiting vehicle 614 to a plurality of parking spaces 616. The transiting vehicle 614 is initially guided through devices such as painted arrows 618. The AR engine 153/253 provides the additional vehicular AR-based guidance in the form of the overhead view display of the respective vehicle 614 as shown in FIG. 6 as a virtual vehicle 654. The AR engine 153/253 also generates virtual objects that are similar to their real world counterparts, for example, as shown, the walls 610 are displayed as a virtual walls 660. In addition, a plurality of virtual arrows 668 are presented to the operator of the vehicle 614 to drive toward the designated parking space 666.

In some embodiments, the vehicle movement and position engine 156/256 is used for identifying that the respective vehicle 614 is one of fully-autonomous, semi-autonomous, or non-autonomous and is approaching the entrance 604 of the parking facility 602 as the vehicle 614 is discovered by sensing devices such as the camera 608 or other IoT devices 180-7 (see FIG. 1A) (including vehicle-mounted cameras) and AR-based vision enhancements such as the AT goggles/glasses 180-8. In addition, in some embodiments, the artificial intelligence platform 150 uses the autonomous vehicles collaboration manager 152/252, and more specifically, the vehicle movement and position engine 156/256 (see FIGS. 1B and 2) to determine if the incoming vehicle 614 is assigned to general parking or assigned parking. Those vehicles 614 that are assigned a specific parking space are directed to that space using at least a portion of the features described herein. Those vehicles 614 assigned to general parking use the features described as follows. Furthermore, in some embodiments the vehicle movement and position engine 156/256 facilitates occupant-centric functions that include identifying the total number of occupants from the total number of vehicles 302 that will be either offboarding or onboarding at the parking facility 602, including the number and identities of each of the vehicles 302 (and their occupants) that are lined up as a string of vehicles (only two vehicles 302 shown in FIG. 6).

In one or more embodiments, the vehicle movement and position engine 156/256 facilitates one or more vehicle-centric functions that include, without limitation, each autonomous vehicle 302 collaborating with each other with respect to identifying the respective vehicular door specifications, including, without limitation, the range of opening angles of the doors with respect to offboarding and onboarding occupants. Moreover, the vehicle movement and position engine 156/256 facilitates one or more vehicle-centric functions that include, without limitation, the vehicles in the vicinity of the offboarding point collaborating with each other via the surrounding IoT ecosystem through, for example, and without limitation, the IoT devices 180-7 and the AR-based vision enhancements such as the AT goggles/glasses 180-8, to identify the appropriate available space 666 in the parking surroundings for the vehicle 654 to stop. Such IoT devices 180-7 may include additional parking facility cameras 608 and vehicle-mounted cameras.

Further, in some embodiments, the space reduction engine 160/260 (see FIGS. 1B and 2) facilitates assigning the appropriate parking space 666 such that the occupants that need to be offboarded or onboarded are provided with the optimum surroundings to provide optimum passage. This feature includes using the determined passage to and from the vehicle 614 to identify which doors of the vehicle 614 can be opened to avoid interference with adjacent vehicles 670 and avoid creating any obstacles to passage of the occupants, and which doors of the vehicle 614 are to remained closed, including identifying which vehicles can open doors on both sides to allow the occupants to exit and enter the respective vehicles more expeditiously.

In some embodiments, the space reduction engine 160/260 facilitates one or more vehicle-centric functions that include, without limitation, each autonomous vehicle 614 and 670 collaborating with each other with respect to identifying the respective vehicular door specifications, including, without limitation, the range of opening angles of the doors with respect to offboarding and onboarding occupants. Accordingly, based on the collaboration of the vehicles 614 and 670, the dimensions of each vehicle are identified so that the vehicular dimensions, for example, and without limitation are considered for creating optimized passage for the offboarding and onboarding occupants. In addition, the space reduction engine 160/260 facilitates one or more occupant-centric functions that include, without limitation, identifying which occupants need to exit/enter the vehicle at the destination, including those multiple occupants that will also be offboarding/onboarding in the same place within an established timeframe. Accordingly, such collaboration facilitates determining a location to park the vehicle, including an angle, direction, and physical position of the vehicle at least partially based on the calculated locations of the other vehicles within the vicinity of the parking area.

Moreover, in some embodiments, the space reduction engine 160/260 facilitates one or more vehicle-centric functions that include, without limitation, the vehicles in the vicinity of the offboarding point at the parking space 666 collaborating with each other via the surrounding IoT ecosystem through, for example, and without limitation, the IoT devices 180-7, to identify the appropriate available space in the parking surroundings for the vehicle to park. In addition, in some embodiments, the locations of the other vehicles 670 (shown virtually in FIG. 6) within the parking facility 602, regardless of the level of autonomy may be discovered through visual means of the operator of the vehicle 614.

Furthermore, in some embodiments, for example, those more complicated parking configurations 400, 420, and 440 (see FIGS. 4A, 4B, and 4C, respectively) rather than the simpler conditions shown in FIG. 6, the space reduction engine 160/260 facilitates one or more vehicle-centric functions that include, without limitation, the respective autonomous vehicle 614 analyzing the surrounding vicinity and identifying how the autonomous vehicle 614 is to be placed to position the optimum number of vehicles 614 and 670 in the designated area constraints.

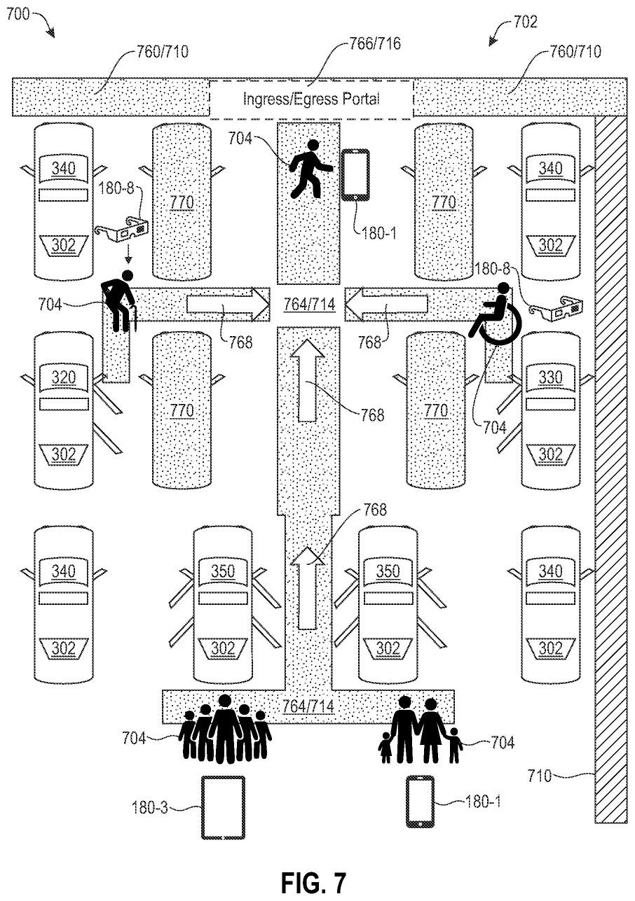

Referring to FIG. 7, a schematic diagram is presented illustrating one possible augmented reality assist 700 for a plurality of occupants 704 transiting from their respective autonomous vehicles 302 (as shown in FIG. 3) using the system 100 (as shown and described with respect to FIGS. 1A-2), in accordance with some embodiments of the present disclosure. In at least some embodiments, a parking facility 702 is presented that shares similar characteristics as those parking facilities shown and described with respect to FIGS. 4A, 4B, 4C, and 6. The parking facility 702 also includes one or more walls 710 that define a plurality of paths 714 to guide the occupants 704 toward an ingress/egress portal 716.

In one or more embodiments, the AR engine 153/253 (see FIGS. 1B and 2) facilitates one or more occupant-centric functions that include, without limitation, intercommunications between the autonomous vehicles 302 with respect to the respective occupants' 704 mobility paths in the surroundings of the respective vicinities of the respective vehicles 302 with AR glasses/goggles 180-8-based guidance so that the occupants 704 can safely and expeditiously exit, transit from, transit toward, and enter the respective vehicles 302. In some embodiments, the AR engine 153/253 provides the occupant AR-based guidance as a first person view (FPV) through the AR glasses/goggles 180-8 worn by one or more of the respective occupants 704. In some embodiments, the AR engine 153/253 facilitates collaboration between the respective vehicle 302 and other nearby vehicles 302, as well as the AR devices of the occupants 704 through their AR glasses/goggles 180-8, mobile phones 180-1, and tablets 180-3 to generate an AR overlay. This AR overlay is used to identify if the occupants 704 from multiple vehicles 302 need to be dropped off at the same location, including prior to the designated destination. Also, this AR overlay facilitates further guiding the occupants 704 through a best mode occupant pathway 714 to transit from and transit to the vehicle 302 as appropriate, including which doors should remain closed/locked to prevent any door collisions, etc. In some embodiments, the AR engine 153/253 proactively guides the occupants 704 to optimum positions for onboarding either a particular vehicle 302, or any other vehicle 302, if the occupants 704 are heading toward the same stop to facilitate the designated door-opening scheme to minimize a potential for contact between the doors of adjacent vehicles 302 and presenting an obstruction to exiting occupants 704.

Also, in one or more embodiments, the AR engine 153/253 provides the additional occupant AR-based guidance in the form of an AR overlay including generated virtual objects that are similar to their real world counterparts. For example, as shown, the path 714 is displayed as a virtual path 764, the wall 710 as a virtual wall 760, the parked vehicles as virtual vehicles 770, and a plurality of virtual arrows 768.

In addition, in one or more embodiments, the vehicle movement and position engine 156/256 (see FIGS. 1B and 2) facilitates one or more occupant-centric functions that include, without limitation, identifying which occupants 704 need to exit/enter the vehicle 302 at the parking facility 702, including those multiple occupants that will also be offboarding/onboarding in the same place within an established timeframe. In some embodiments, these features are executed in conjunction with the AR engine 153/253, the vehicle movement and position engine 156/256, and the space reduction engine 160/260 (see FIGS. 1B and 2). Furthermore, the vehicle movement and position engine 156/256 additionally facilitates occupant-centric functions that include identifying the total number of occupants 704 from the total number of vehicles 302 that will be either offboarding or onboarding at the parking facility 702. Also, the vehicle movement and position engine 156/256 facilitates occupant-centric functions that include identifying for each vehicle 302 the occupants' 704 profiles and the present, or intended, occupants' 704 positions in the vehicle 302 to identify if the occupants 704 can offboard or onboard from one side of the vehicle 302 or the other side.

Further, in at least some embodiments, the vehicle movement and position engine 156/256 facilitates assigning the appropriate parking space such that the occupants 704 that need to be offboarded or onboarded are provided with the optimum surroundings to provide optimum passage. This feature includes using the determined passage to and from the vehicle 302 to identify which doors of the vehicles 302 can be opened to avoid interference with adjacent vehicles 302 and avoid creating any obstacles to passage of the occupants 704, and which doors of the vehicle 302 are to remained closed, including identifying which vehicle can open doors on both sides to allow the occupants 704 to exit and enter the respective vehicles 302 more expeditiously.

In addition, in at least some embodiments, the occupant walking pathway highlighting engine 162/262 facilitates one or more occupant-centric functions that include, without limitation, tracking the real time offboarding and/or onboarding information of the occupants 704 from the vehicle 302 and identifying which occupants 704 are no longer required to be unloaded or loaded. These features are in addition to the features described above for augmenting real time access to, traversal of, parking within, and occupant passage through the parking facility 702.

Moreover, the occupant walking pathway highlighting engine 162/262 facilitates one or more occupant-centric functions that include, without limitation, intercommunications between the autonomous vehicles 302 with respect to the respective occupants' 704 mobility paths in the surroundings of the respective vicinities of the respective vehicles with AR-based guidance so the occupants 704 can safely and expeditiously exit and enter the respective vehicles 302. In addition, the occupant walking pathway highlighting engine 162/262 facilitates the maintenance of the real time number of occupants 704 in the plurality of autonomous vehicles 302 and the historical data for the occupants, i.e., the known occupant attributes data 175.

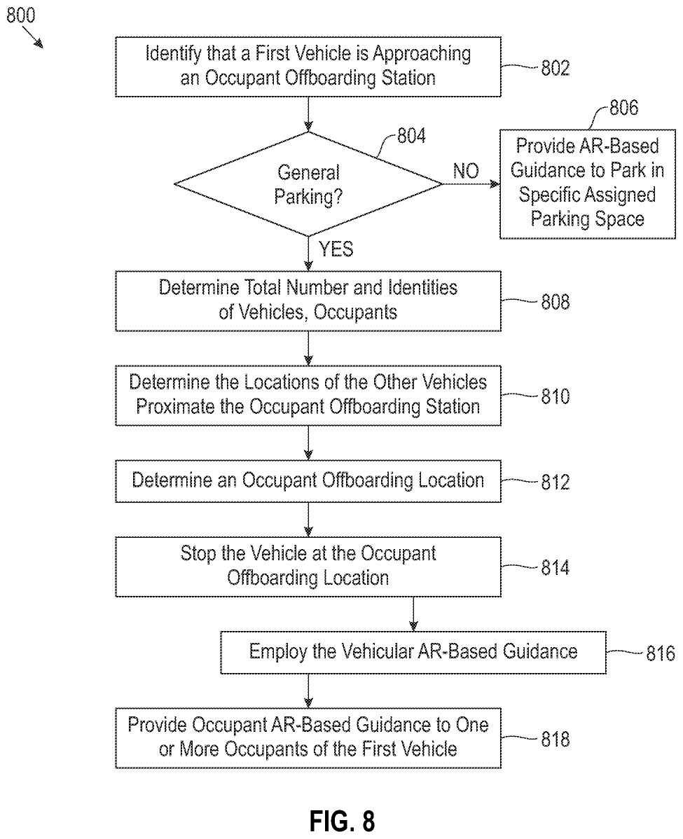

Referring to FIG. 8, a flowchart is presented illustrating a process 800 for enhancing offboarding of occupants associated with autonomous vehicles through augmented reality (AR), in accordance with some embodiments of the present disclosure. Also referring to FIGS. 1A-7, the process 800 includes identifying that a first vehicle 302 (shown as vehicle 614 in FIG. 6) is approaching an occupant offboarding station, e.g., and without limitation, the vehicle/passenger loading area 502, the parking facility 602, and the parking facility 702, where the first vehicle 302 is an autonomous vehicle. In some embodiments, the vehicle movement and position engine 156/256 is also used for identifying if the respective vehicle 614 is one of fully-autonomous, semi-autonomous, or non-autonomous and as the vehicle 614 approaches the entrance 604 of the parking facility 602, where the vehicle 614 is discovered by sensing devices such as the camera 608 or other IoT devices 180-7 and AR-based vision enhancements such as the AT goggles/glasses 180-8.

In some embodiments, the artificial intelligence platform 150 uses the autonomous vehicles collaboration manager 152/252, and more specifically, the vehicle movement and position engine 156/256 to determine 804 if the incoming vehicle 614 is assigned to general parking or assigned parking. Those vehicles 614 that are assigned a specific parking space (i.e., a “NO” determination) are directed 806 to that space using at least a portion of the features described herein, including the AR features through the AR engine 153. Those vehicles 614 assigned to general parking (i.e., a “YES” determination) use the features described as follows.

In at least some embodiments, the process 800 also includes determining 808, through the vehicle movement and position engine 156/256, the total number of occupants from the total number of vehicles 302 that will be either offboarding or onboarding at the parking facility 602 (or the vehicle/passenger loading area 502), including the number and identities of each of the vehicles 302 (and their occupants) that are lined up as a string 508 of vehicles (only two vehicles 302 shown in FIG. 6).

Also, in some embodiments, the process 800 includes determining 810 a location of one or more second vehicles 302 proximate to the occupant offboarding station. Such determinations are made through one or more of vehicle-to-vehicle collaboration, AR features, and other sensors (e.g., cameras), all as discussed in more detail herein. Also, subject to the one or more second vehicles location determinations 810, the process 800 includes determining 812 an occupant offboarding location (the offboarding/onboarding pavement 504 of FIG. 5 and the parking space 666 of FIG. 6) for the first vehicle (302/614) proximate to the occupant offboarding station (the vehicle/passenger loading area 502 of FIG. 5 and the parking facility 602 of FIG. 6). Once the parking or stopping location is known, the process 800 includes stopping 814 the first vehicle 302/614 proximate to the occupant offboarding location 504/666 through the employment 816 of the AR-based guidance for positioning the vehicle as described in detail elsewhere herein. In at least some embodiments, the vehicular AR-based guidance is provided as an overhead view display of the first vehicle 302/614, where the vehicular AR-based guidance is presented to the occupant as virtual objects configured to guide the first vehicle 302/614 to the occupant offboarding location 504/666.

Further, in at least some embodiments, the process 800 includes providing 818 occupant AR-based guidance to one or more occupants 704 of the first vehicle 302/614 to offboard the first vehicle 302/614. As described further elsewhere herein, the providing 818 step includes providing the occupant AR-based guidance to offboard (or onboard) the first vehicle 302/614 through a first person view (FPV) via an AR device worn or carried by the one or more occupants.

The embodiments as disclosed and described herein are configured to provide an improvement to human transport technology. Materials, operable structures, and techniques as disclosed herein can provide substantial beneficial technical effects. Some embodiments may not have all of these potential advantages and these potential advantages are not necessarily required of all embodiments. By way of example only, and without limitation, one or more embodiments may provide enhancements of using AR features to enhance onboarding and offboarding of occupants of autonomous vehicles, thereby integrating AR technology and autonomous vehicle technology into a practical application that improves the transport of humans.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

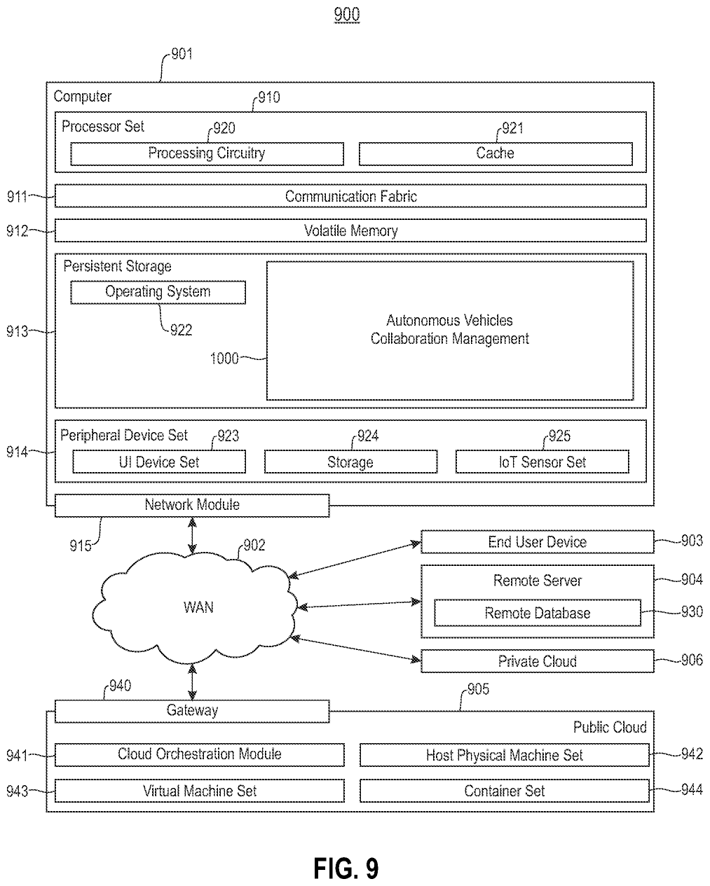

Referring to FIG. 9, a block schematic diagram is presented illustrating an example of a computing environment for the execution of at least some of the computer code involved in performing the disclosed methods described herein, in accordance with some embodiments of the present disclosure.

Computing environment 900 contains an example of an environment for the execution of at least some of the computer code involved in performing the disclosed methods, such as managing autonomous vehicles collaboration 1000. In addition to block 1000, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 1000, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 921 and the other storage media discussed below. The program instructions, and associated data, are accessed by processor set 910 to control and direct performance of the disclosed methods. In computing environment 900, at least some of the instructions for performing the disclosed methods may be stored in block 1000 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 1000 typically includes at least some of the computer code involved in performing the disclosed methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the disclosed methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for enhancing offboarding of occupants associated with autonomous vehicles through augmented reality (AR) comprising:
one or more processing devices;
one or more memory devices communicatively and operably coupled to the one or more processing devices; and
an autonomous vehicles collaboration manager communicatively and operably coupled to the one or more processing devices;
one or more AR devices communicatively and operably coupled to the autonomous vehicles collaboration manager, the autonomous vehicles collaboration manager configured to:
identify that a first vehicle is approaching an occupant offboarding station, wherein the first vehicle is an autonomous vehicle;
determine a location of one or more second vehicles proximate to the occupant offboarding station;
determine, subject to the one or more second vehicles location determinations, an occupant offboarding location for the first vehicle proximate to the occupant offboarding station; and
stop the first vehicle proximate to the occupant offboarding location through providing vehicular AR-based guidance to the first vehicle to stop.

2. The system of claim 1, wherein the autonomous vehicles collaboration manager is further configured to:
provide occupant AR-based guidance to one or more occupants of the first vehicle to offboard the first vehicle.

3. The system of claim 2, wherein the autonomous vehicles collaboration manager is further configured to:
provide the occupant AR-based guidance as a first person view (FPV) through an AR device worn by the one or more occupants.

4. The system of claim 1, wherein the autonomous vehicles collaboration manager is further configured to:
provide the vehicular AR-based guidance to one or more occupants of the first vehicle to onboard the first vehicle.

5. The system of claim 1, wherein the autonomous vehicles collaboration manager is further configured to:
provide the vehicular AR-based guidance as an overhead view display of the first vehicle.

6. The system of claim 1, wherein the autonomous vehicles collaboration manager is further configured to:
induce the first vehicle to collaborate with the one or more second vehicles, wherein at least a portion of the one or more second vehicles are autonomous vehicles.

7. The system of claim 1, wherein the autonomous vehicles collaboration manager is further configured to:
provide the vehicular AR-based guidance as virtual objects configured to guide the first vehicle to the occupant offboarding location.

8. A computer program product for enhancing offboarding of occupants associated with autonomous vehicles through augmented reality (AR) comprising:
one or more computer readable storage media; and
program instructions collectively stored on the one or more computer storage media, the program instructions comprising:
program instructions to identify that a first vehicle is approaching an occupant offboarding station, wherein the first vehicle is an autonomous vehicle;
program instructions to determine a location of one or more second vehicles proximate to the occupant offboarding station;
program instructions to determine, subject to the one or more second vehicles location determinations, an occupant offboarding location for the first vehicle proximate to the occupant offboarding station; and
program instructions to stop the first vehicle proximate to the occupant offboarding location through providing vehicular AR-based guidance to the first vehicle to stop.

9. The computer program product of claim 8, further comprising:
program instructions to provide occupant AR-based guidance to one or more occupants of the first vehicle to offboard the first vehicle.

10. The computer program product of claim 9, further comprising:
program instructions to provide the occupant AR-based guidance as a first person view (FPV) through an AR device worn by the one or more occupants.

11. The computer program product of claim 8, further comprising:
program instructions to provide the vehicular AR-based guidance to one or more occupants of the first vehicle to onboard the first vehicle.

12. The computer program product of claim 8, further comprising:
program instructions to provide the vehicular AR-based guidance as an overhead view display of the first vehicle.

13. The computer program product of claim 8, further comprising:
program instructions to induce the first vehicle to collaborate with the one or more second vehicles, wherein at least a portion of the one or more second vehicles are autonomous vehicles; and
program instructions to provide the vehicular AR-based guidance as virtual objects configured to guide the first vehicle to the occupant offboarding location.

14. A computer-implemented method for enhancing offboarding of occupants associated with autonomous vehicles through augmented reality (AR) comprising:
identifying that a first vehicle is approaching an occupant offboarding station, wherein the first vehicle is an autonomous vehicle;
determining a location of one or more second vehicles proximate to the occupant offboarding station;
determining, subject to the one or more second vehicles location determinations, an occupant offboarding location for the first vehicle proximate to the occupant offboarding station; and
stopping the first vehicle proximate to the occupant offboarding location, comprising:
providing vehicular AR-based guidance to the first vehicle to stop.

15. The method of claim 14, further comprising:
providing occupant AR-based guidance to one or more occupants of the first vehicle to offboard the first vehicle.

16. The method of claim 15, wherein the providing occupant AR-based guidance to one or more occupants of the first vehicle to offboard the first vehicle comprises:
providing the occupant AR-based guidance as a first person view (FPV) through an AR device worn by the one or more occupants.

17. The method of claim 14, further comprising:
providing the occupant AR-based guidance to one or more occupants of the first vehicle to onboard the first vehicle.

18. The method of claim 14, wherein the providing the vehicular AR-based guidance to the first vehicle to stop comprises:
providing the AR-based guidance as an overhead view display of the first vehicle.

19. The method of claim 14, wherein the determining an occupant offboarding location for the first vehicle proximate to the occupant offboarding station comprises:
the first vehicle collaborating with the one or more second vehicles, wherein at least a portion of the one or more second vehicles are autonomous vehicles.

20. The method of claim 14, wherein the determining an occupant offboarding location for the first vehicle proximate to the occupant offboarding station comprises:
providing the vehicular AR-based guidance as virtual objects configured to guide the first vehicle to the occupant offboarding location.
